(19) United States
(12) Patent Application Publication
(10) Pub. No.: US 2007/0025442 A1
(43) Pub. Date: Feb. 1, 2007

(54) Coding method for coding moving images

(75) Inventors: Shigeyuki Okada, Ogaki-shi (JP); Yuh Matsuda, Gifu-shi (JP); Hideki Yamauchi, Ogaki-shi (JP); Yasuo Ishii, Anpachi-gun (JP); Mitsuru Suzuki, Anpachi-gun (JP); Shinichiro Okada, Toyohashi-shi (JP)

Correspondence Address: MCDERMOTT WILL & EMERY LLP, 600 13TH STREET, N.W., WASHINGTON, DC, 20005-3096, US

(73) Assignee: Sanyo Electric Co., Ltd.

(21) Appl. No.: 11/494,619

(22) Filed: Jul. 28, 2006

(30) Foreign Application Priority Data
Jul. 28, 2005 (JP) 2005-219592
Sep. 27, 2005 (JP) 2005-280881
Sep. 27, 2005 (JP) 2005-280882

(51) Int. Cl. H04N 11/04; H04N 11/02

(52) U.S. Cl. 375/240.03; 375/240.16

(57) ABSTRACT

A region setting unit 64 sets multiple global regions in a frame image. A bit number adjustment unit 62 adjusts the number of bits of the local motion vectors LMV which are to be obtained for each global region. A local motion vector detection unit 66 detects the local motion vectors LMV with the number of bits adjusted by the bit number adjustment unit 62 in units of macro blocks for each global region. A global motion vector calculation unit 68 calculates the global motion vector GMV which represents the global motion for each global region. A local motion vector difference coding unit 72 calculates the difference ΔLMV, which is the difference between each local motion vector LMV and the global motion vector GMV, for each global region, and performs coding thereof.

### BACKGROUND OF THE INVENTION

1. Field of the Invention

The present invention relates to a coding method for coding moving images.

2. Description of the Related Art

The rapid development of broadband networks has increased consumer expectations for services that provide high-quality moving images. On the other hand, large capacity storage media such as DVD and so forth are used for storing high-quality moving images. This increases the segment of users who enjoy high-quality images. A compression coding method is an indispensable technique for transmission of moving images via a communication line, and storing the moving images in a storage medium. Examples of international standards of moving image compression coding techniques include the MPEG-4 standard, and the H.264/AVC standard. Furthermore, the SVC technique is known, which is a next-generation image compression technique that includes both high quality image streaming and low quality image streaming functions.

Streaming distribution of high-resolution moving images without taking up most of the communication bandwidth, and storage of such high-resolution moving images in a recording medium having a limited storage capacity, require an increased compression ratio of a moving image stream. In order to improve the effects of the compression of moving images, motion compensated interframe prediction coding is performed. With motion compensated interframe prediction coding, a coding target frame is divided into blocks, and the motion between the target coding frame and a reference frame, which has already been coded, is predicted so as to detect a motion vector for each block, and the motion vector information is coded together with the subtraction image.

Japanese Patent Application Laid-open Publication No. 2003-299101 discloses a moving image coding technique having a function of selecting a motion compensation method which exhibits the highest coding efficiency from among the interframe coding, ordinary motion compensation, and various kinds of motion vector compensation using global vectors.

The H.264/AVC standard provides a function of adjusting the motion compensation block size, and a function of selecting the improved motion compensation pixel precision of up to around ¼ pixel precision, thereby enabling finer prediction to be made for the motion compensation. On the other hand, in the development of SVC (Scalable Video Coding), which is a next-generation image compression technique, MCTF (Motion Compensated Temporal Filtering) technique is being studied in order to improve temporal scalability. The MCTF technique is a technique in which the time-base sub-band division technique and the motion compensation technique are combined. With the MCTF technique, motion compensation is performed in a hierarchical manner, leading to significantly increased information with respect to the motion vectors. As described above, according to the recent trends, such a latest moving image coding technique requires the increased overall amount of data for the moving image stream due to the increased amount of information with respect to the motion vectors. This leads to a strong demand for a technique of reducing the coding amount due to the motion vector information.

### SUMMARY OF THE INVENTION

The present invention has been made in view of the aforementioned problems. Accordingly, it is an object thereof to provide a moving image coding technique which offers high coding efficiency and high-precision motion prediction.

With a coding method according to an aspect of the present invention, multiple regions are defined in pictures which are components of a moving image, and which are to be subjected to inter-picture prediction coding, with conditions for motion vector coding being set for each region.

The term “picture” as used here represents a coding unit such as a frame, field, or VOP (Video Object Plane).

According to such an aspect of the present invention, moving images can be coded with the motion vector coding conditions adjusted for each region.

The aforementioned conditions for motion vector coding may be conditions with respect to the pixel precision for motion compensation. Also, the aforementioned conditions for motion vector coding may be conditions with respect to the maximum value possible for the motion vector. Also, the aforementioned conditions for motion vector coding may be a combination of conditions such as these. Such an arrangement provides at least one variable condition selected from the aforementioned conditions, i.e., the pixel precision for motion compensation and the maximum value possible for the motion vector, which can be adjusted for each region, for the coding of moving images. Furthermore, with such an arrangement, these coding conditions may be adjusted to be the optimum conditions for each region, thereby creating optimized coded data for the moving images.

The aforementioned conditions for motion vector coding may be included in coded data of the moving images in a form in which a set of corresponding conditions is correlated with each region where said conditions are to be applied. With such an arrangement, a coded moving image can be decoded with reference to various kinds of conditions that have been used for coding each region.

Also, the motion vectors may be obtained for each of the aforementioned multiple regions after the adjustment of at least one of the pixel precision for motion compensation and the maximum value possible for the motion vector. Furthermore, the motion vectors thus obtained may be coded, and the motion vectors thus coded may be included in the aforementioned coded data.

The number of bits assigned to the motion vectors which are to be obtained for each region may be adjusted by varying the pixel precision for the motion compensation for each region. Such an arrangement enables the number of bits of the motion vector to be adjusted corresponding to the required pixel precision, thereby handling a case in which the required pixel precision for the motion compensation differs for each region. This allows the motion vector coding amount to be reduced.

The number of bits assigned to the motion vectors which are to be obtained for each region may be adjusted by varying the maximum value possible for the motion vector for each region. Furthermore, the maximum value possible for the motion vector may be adjusted according to the area of the motion search region for each region. Such an arrangement enables the number of bits assigned to the motion vector to be adjusted corresponding to the amount of motion, thereby handling a case in which the amount of motion differs for each region. This allows the motion vector coding amount to be reduced.

Another aspect of the present invention provides a coding device. The coding device comprises: a region setting unit for setting multiple regions in pictures which are to be subjected to inter-picture prediction coding for moving images; an adjustment unit for adjusting at least one of the motion compensation pixel precision and the maximum value possible for the motion vector for each region; a motion vector detection unit for detecting a motion vector for each of the multiple regions based on to the conditions adjusted by the aforementioned adjustment unit; and a motion vector coding unit for coding the motion vectors thus obtained.

Yet another aspect of the present invention provides a data structure of a moving image stream. With regard to this data structure of a moving image stream, the pictures of the moving image are coded. Furthermore, the motion vector is obtained for each of multiple regions, which have been defined in pictures which are to be subjected to inter-picture prediction coding for moving images, after the adjustment of at least one of the pixel precision for motion compensation and the maximum value possible for the motion vector. The motion vectors thus obtained for each region are coded. The aforementioned data structure comprises the motion vectors thus coded and the pictures of the moving image thus coded.

According such an aspect of the present invention, the motion vector is obtained for each region, and coding thereof is performed after the adjustment of at least one of the pixel precision for motion compensation and the maximum value possible for the motion vector in units of the aforementioned regions. This provides a moving image stream with optimized motion vectors.

Note that any combination of the aforementioned components or any manifestation of the present invention realized by modification of a method, device, system, computer program, and so forth, is effective as an embodiment of the present invention.

### BRIEF DESCRIPTION OF THE DRAWINGS

FIG. 1 is a configuration diagram which shows a coding device according to an embodiment 1;

FIG. 2 is a diagram for describing the configuration of a motion compensation unit shown in FIG. 1;

FIG. 3 is a flowchart for describing the procedure of motion vector difference coding performed by the motion compensation unit shown in FIG. 2:

FIGS. 4A through 4C are diagrams for describing examples in which the regions are set in an image by a region setting unit shown in FIG. 2;

FIGS. 5A through 5C are diagrams for describing examples in which a global motion vector difference is calculated by a global motion vector difference coding unit shown in FIG. 2;

FIG. 6 is a diagram for describing the number of bits of a local motion vector adjusted by a bit number adjustment unit shown in FIG. 2;

FIG. 7 is a configuration diagram which shows a decoding device according to the embodiment 1;

FIG. 8 is a diagram for describing the configuration of a motion compensation unit shown in FIG. 7;

FIG. 9 is a diagram which shows the configuration of a coding device according to an embodiment 2;

FIG. 10 is a diagram which shows the configuration of a motion compensation unit shown in FIG. 9;

FIG. 11 is a diagram for describing the change in the coding amount due to the change in the size of the quantization scale and the change in the motion vector precision;

FIG. 12 is a configuration diagram which shows a coding device according to an embodiment 3;

FIG. 13 is a diagram which shows a method for creating a low-frequency frame;

FIG. 14 is a diagram which shows a method for creating a high-frequency frame;

FIG. 15 is a configuration diagram which shows an MCTF processing unit;

FIG. 16 is a diagram which shows images and motion vectors output for each layer;

FIG. 17 is a flowchart which shows a coding method according to the MCTF technique;

FIG. 18 is a diagram which shows a data structure in which motion vector precision data is stored for each layer;

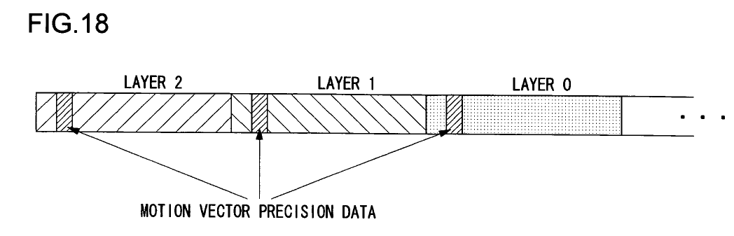

FIG. 19 is a table which shows an example of the relation between the frame rate and the motion vector precision for each layer; and

FIG. 20 is a configuration diagram which shows a decoding device according to an embodiment 3.

### DETAILED DESCRIPTION OF THE INVENTION

The invention will now be described by reference to the preferred embodiments. This does not intend to limit the scope of the present invention, but to exemplify the invention.

### Embodiment 1

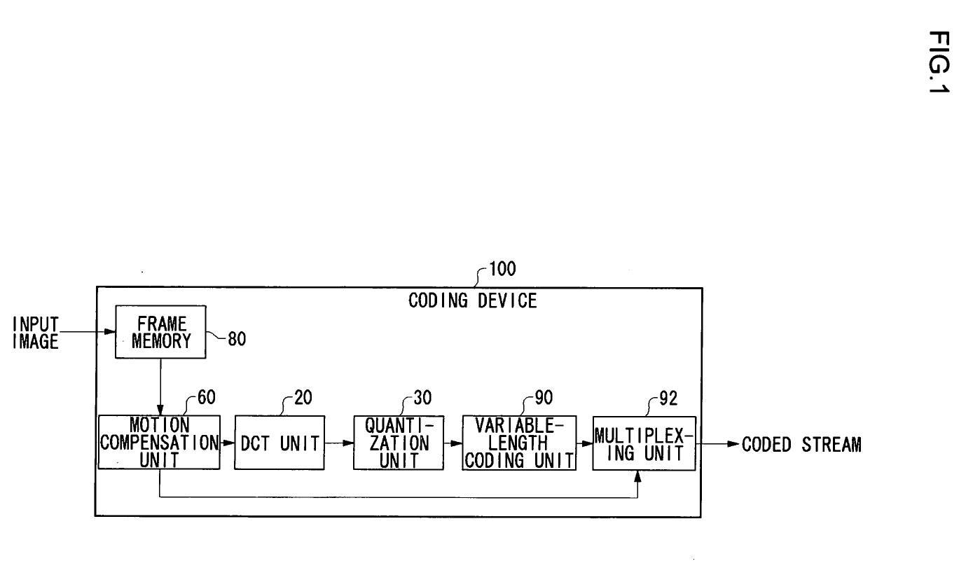

FIG. 1 is a configuration diagram which shows a coding device 100 according to an embodiment 1. This configuration can be realized by hardware means, e.g., by actions of a CPU, memory, and other LSIs, of a computer, or by software means, e.g., by actions of a program having a function of image coding or the like, loaded into the memory. Here, the drawing shows a functional block configuration which is realized by cooperation between the hardware components and software components. It is needless to say that such a functional block configuration can be realized by hardware components alone, software components alone, or various combinations thereof, which can be readily conceived by those skilled in this art.

The coding device 100 according to the present embodiment performs coding of moving images according to the MPEG (Moving Picture Experts Group) series standards (MPEG-1, MPEG-2, and MPEG-4) standardized by ISO (International Organization for Standardization)/IEC (International Electrotechnical Commission), the H.26x series standards (H.261, H.262, and H.263) standardized by the international standardization organization with respect to electric communication ITU-T (International Telecommunication Union-Telecommunication Standardization Sector), or the H.264/AVC standard which is the newest moving image compression coding standard jointly standardized by both the aforementioned standardization organizations (these organizations have advised that this H.264/AVC standard should be referred to as “MPEG-4 Part 10: Advanced Video Coding” and “H.264”, respectively).

With the MPEG series standards, in a case of coding an image frame in the intra-frame coding mode, the image frame to be coded is referred to as “I (Intra) frame”. In a case of coding an image frame with a prior frame as a reference image, i.e., in the forward interframe prediction coding mode, the image frame to be coded is referred to as “P (Predictive) frame”. In a case of coding an image frame with a prior frame and an upcoming frame as reference images, i.e., in the bi-directional interframe prediction coding mode, the image frame to be coded is referred to as “B frame”.

On the other hand, with the H.264/AVC standard, image coding is performed using reference images regardless of the time at which the reference images have been acquired. For example, image coding may be made with two prior image frames as reference images. Also, image coding may be made with two upcoming image frames as reference images. Furthermore, the number of the image frames used as the reference images is not restricted in particular. For example, image coding may be made with three or more image frames as the reference images. Note that, with the MPEG-1, MPEG-2, and MPEG-4 standards, the term “B frame” represents the bi-directional prediction frame. On the other hand, with the H.264/AVC standard, the time at which the reference image is acquired is not restricted in particular. Accordingly, the term “B frame” represents the bi-predictive prediction frame.

While description will be made in the embodiment 1 regarding an arrangement in which coding is performed in units of frames, coding may be performed in units of fields. Also, coding may also be performed in units of VOP as stipulated in the MPEG-4.

The coding device 100 receives the input moving images in units of frames, performs coding of the moving images, and outputs a coded stream. The moving image frames thus input are stored in frame memory 80.

A motion compensation unit 60 performs motion compensation for each macro block of a P frame or B frame using a prior or upcoming image frame stored in the frame memory 80 as a reference image, thereby creating the motion vector and the predicted image. The motion compensation unit 60 makes a subtraction between the image of the P frame or B frame to be coded and the predicted image, and supplies the subtraction image to a DCT unit 20. Furthermore, the motion compensation unit 60 supplies the coded motion vector information to a multiplexing unit 92.

The DCT unit 20 performs discrete cosine transform (DCT) processing for the image supplied from the motion compensation unit 60, and supplies the DCT coefficients thus obtained, to a quantization unit 30.

The quantization unit 30 performs quantization of the DCT coefficients and supplies the quantized DCT coefficients to the variable-length coding unit 90. The variable-length coding unit 90 performs variable-length coding processing for the quantized DCT coefficients of the subtraction image, and transmits the DCT coefficients subjected to the variable-length coding processing to the multiplexing unit 92. The multiplexing unit 92 multiplexes the coded DCT coefficients received from the variable-length coding unit 90 and the coded motion vector information received from the motion compensation unit 60, thereby creating a coded stream. The multiplexing unit 92 creates a coded stream while sorting the coded frames in order of time.

Description has been made regarding coding processing for a P frame or B frame, in which the motion compensation unit 60 operates as described above. On the other hand, in a case of coding processing for an I frame, the I frame subjected to intra-frame prediction is supplied to the DCT unit 20 without involving the motion compensation unit 60. Note that this coding processing is not shown in the drawings.

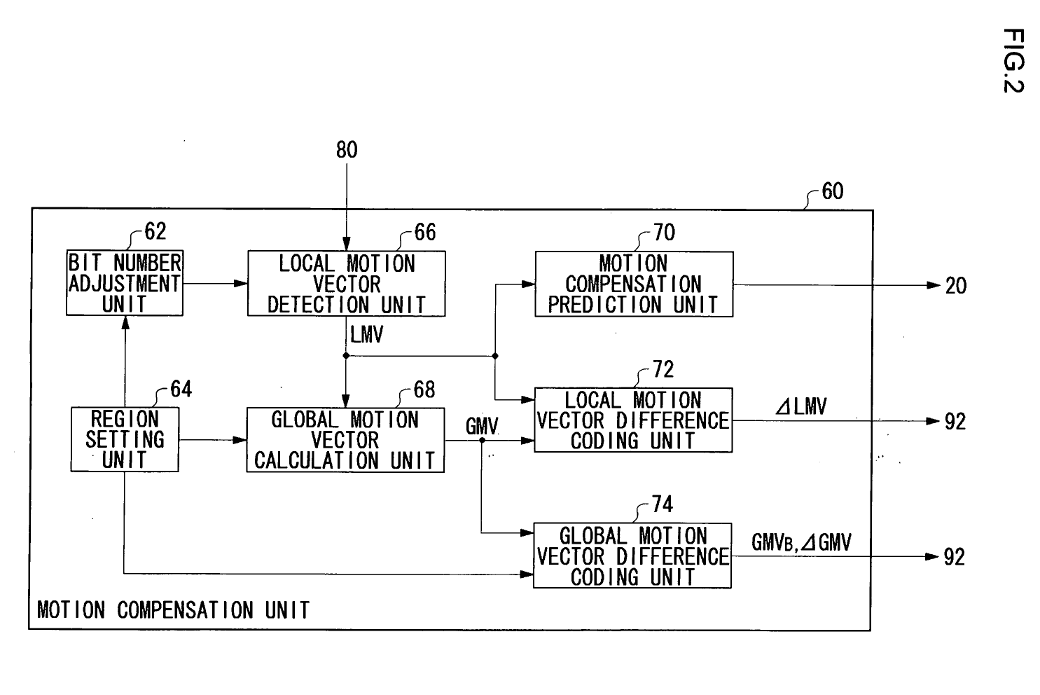

FIG. 2 is a diagram for describing the configuration of the motion compensation unit 60. The motion compensation unit 60 detects a motion vector for each macro block in a coding target image (which will be referred to as “local motion vector” hereafter). At the same time, the motion compensation unit 60 obtains a motion vector which indicates the global motion within the region for each of the predetermined regions set in the image (which will be referred to as “global motion vector” hereafter). The motion compensation unit 60 performs motion prediction based upon the local motion vector, and outputs a subtraction image. At the same time, the motion compensation unit 60 performs coding of the difference between each of the local motion vectors and the global motion vector, and outputs the calculation results in the form of motion vector information.

A region setting unit 64 sets a region for calculating the global motion vector GMV in a frame image (which will be referred to as “global region” hereafter) Note that the region setting unit 64 sets multiple global regions in the image. For example, the region setting unit 64 may set fixed global regions in the image beforehand. Specific examples include: an arrangement in which the region setting unit 64 sets one global region around the center of the frame image, and sets the peripheral region other than the center region to be another global region; etc. Alternatively, the global regions may be set by the user.

Also, an arrangement may be made in which, in a case that the image includes a particular object such as a human figure or the like, the region setting unit 64 automatically extracts the region occupied by the object, which can have any shape, and the region thus extracted is set to be a global region.

Also, an arrangement may be made in which the region setting unit 64 automatically extracts a region occupied by the macro blocks having roughly the same motion with reference to the local motion vectors LMV in the image detected by a local motion vector detection unit 66, and sets the region thus extracted to be a global region.

The region setting unit 64 transmits the information with respect to the global regions thus set, to a bit number adjustment unit 62, a global motion vector calculation unit 68, and a global motion vector difference coding unit 74.

The bit number adjustment unit 62 adjusts the number of bits of the local motion vectors LMV, which are to be obtained for each global region, by determining the size of the search region and the pixel precision of the motion compensation for each global region set by the region setting unit 64.

For example, the bit number adjustment unit 62 adjusts the number of bits of the local motion vector LMV by setting the pixel precision of the motion compensation to be a pixel precision of pixels, ½ pixels, ¼ pixels, or the like. In a case of motion compensation with the integer number of pixel precision, the local motion vector LMV is represented by the bits of the integer part only. On the other hand, in a case of ½ pixel precision or ¼ pixel precision, the local motion vector LMV requires the bits of the decimal part, in addition to the bits of the integer part. Specifically, in a case of ½ pixel precision, the local motion vector LMV requires one additional bit for the decimal part. Also, in a case of ¼ pixel precision, the local motion vector LMV requires two additional bits for the decimal part.

Also, the bit number adjustment unit 62 can adjust the number of bits of the local motion vector LMV by varying the maximum value possible for the local motion vector LMV for each global region. With such an arrangement, the bit adjustment unit 62 adjusts the digit of the integer part of the local motion vector LMV based upon the size of the motion search region in each global region, the amount of motion in each global region, and so forth, thereby adjusting the maximum value possible for the local motion vector LMV.

The local motion vector detection unit 66 detects the predicted macro block which exhibits the least difference from the target macro block in the coding target image with reference to the reference image held by the frame memory 80, and obtains the local motion vector LMV which represents the motion from the target macro block to the predicted macro block. This motion detection is performed by searching the reference image for the reference macro block that matches the target macro block, with the size of the motion search region and the pixel precision set by the bit number adjustment unit 62. In general, searching is repeatedly performed multiple times within a pixel region, and the reference macro block which is best suits the target macro block is selected as the predicted macro block.

The local motion vector detection unit 66 transmits the local motion vector LMV, which has been obtained with the number of bits adjusted by the bit number adjustment unit 62, to the global motion vector calculation unit 68, a motion vector prediction unit 70, and a local motion vector difference coding unit 72.

The motion compensation prediction unit 70 performs motion compensation for the target macro block using the local motion vector LMV, thereby creating a predicted image. Furthermore, the motion compensation prediction unit 70 creates a subtraction image by making a subtraction between the coding target image and the predicted image, and outputs the subtraction image to the DCT unit 20.

The global motion vector calculation unit 68 calculates the global motion vector GMV which indicates the global motion in each global region set by the region setting unit 64. For example, the global motion vector calculation unit 68 calculates the average of the local motion vectors LMV within a region, and employs the average as the global motion vector GMV. Here, the number of bits of the global motion vector GMV for each global region is the same as the number of bits of the local motion vectors LMV obtained for each global region, which is the number of bits adjusted by the bit number adjustment unit 62.

Furthermore, an arrangement may be made in which the global motion vector calculation unit 68 acquires the information with respect to the global motion in each global region, and calculates the global motion vector GMV for each global region based upon the information thus acquired. For example, an arrangement may be made in which, in a case of the camera zooming or panning, or in a case of scrolling the screen, the global motion vector calculation unit 68 determines the global motion for each global region based upon the information with respect to the overall region of the screen, thereby calculating the global motion vector GMV. Also, an arrangement may be made in which the global motion vector calculation unit 68 automatically extracts the motion of a particular object such as a human figure or the like in the image, and determines the global motion for each global region based upon the motion of that object, thereby calculating the global motion vector GMV.

The global motion vector calculation unit 68 transmits the global motion vector GMV, which has been obtained with the number of bits having been adjusted by the bit number adjustment unit 62, to the local motion vector difference coding unit 72 and the global motion vector difference coding unit 74.

The local motion vector difference coding unit 72 receives the local motion vector LMV from the local motion vector detection unit 66, and receives the global motion vector GMV from the global motion vector calculation unit 68, respectively. Then, the local motion vector difference coding unit 72 calculates the difference between the local motion vector LMV and the global motion vector GMV for each global region, i.e., the local motion vector difference ΔLMV=LMV−GMV, and performs variable length coding of the local motion vector difference ΔLMV. The local motion vector difference coding unit 72 transmits the coded local motion vector difference ΔLMV to the multiplexing unit 92.

The global motion vector difference coding unit 74 receives the global motion vector GMV for each region as an input from the global motion vector calculation region 68, and selects at least one global motion vector GMV as a reference from among the set of global motion vectors GMV, each of which is obtained for the corresponding region. The global motion vector GMV which is selected as a reference will be referred to as the “reference global motion vector GMV_{B}”. The global motion vector difference coding unit 74 calculates the difference ΔGMV=GMV−GMV_{B}, and performs variable length coding of the reference motion vector GMV_{B} and the global motion vector difference ΔGMV.

The global motion vector difference coding unit 74 transmits the coded reference global motion vector GMV_{B} and the coded global motion vector difference ΔGMV for each global region to the multiplexing unit 92 in the form of motion vector information. In this stage, the global motion vector difference coding unit 74 appends the region information with respect to the global region set by the region setting unit 64 as a part of the motion vector information. Furthermore, the global motion vector difference coding unit 74 appends the information with respect to the motion compensation parameters such as the size of the motion search region for each global region, the pixel precision of the motion compensation, the maximum value possible for the local motion vector LMV, and so forth, as a part of the motion vector information. Note that a decoding device 300 performs motion compensation with reference to these various kinds of motion compensation parameters.

The multiplexing unit 92 receives the reference global motion vector GMV_{B}, the global motion vector difference ΔGMV, and the local motion vector difference ΔLMV, in the form of the motion vector information.

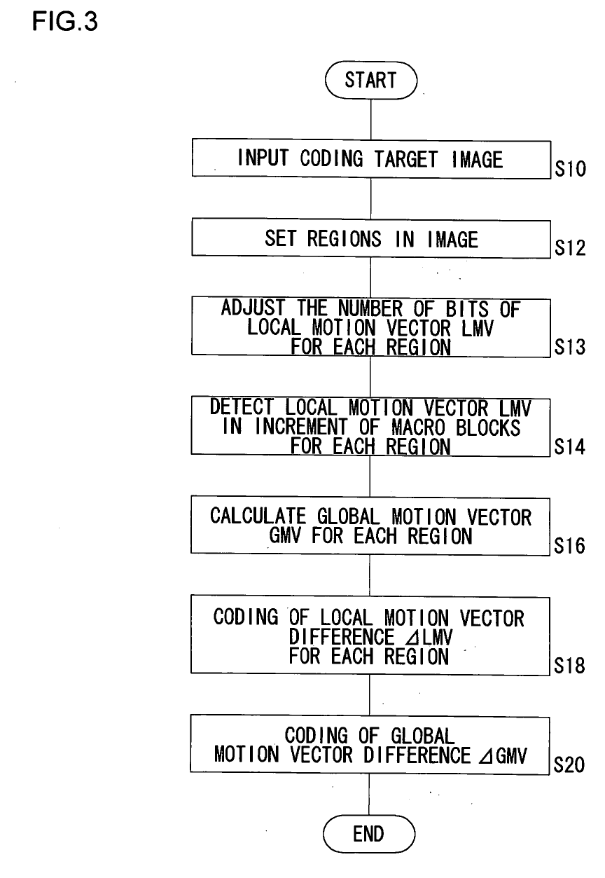

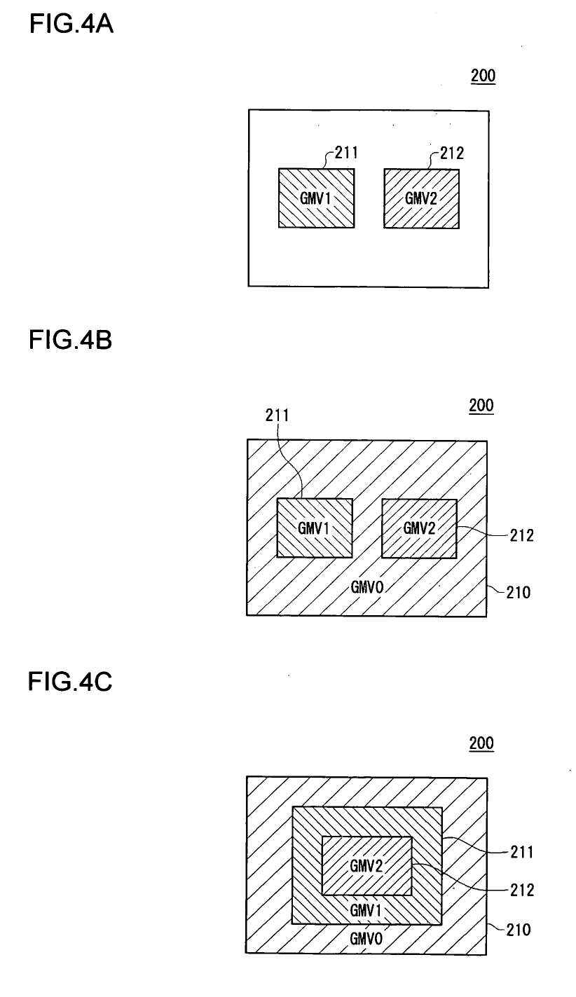

FIG. 3 is a flowchart for describing the coding procedure for the motion vector difference performed by the motion compensation unit 60. Description will be made regarding the coding procedure with reference to examples shown in FIGS. 4 through 6, as appropriate.

A coding target image is input to the frame memory 80 of the coding device 100 (S10). The region setting unit 64 sets a global region in the image (S12). The bit number adjustment unit 62 adjusts the number of bits of the local motion vectors LMV for each global region (S13).

The local motion vector detection unit 66 of the motion compensation unit 60 detects the local motion vectors LMV for each macro block with the number of bits adjusted, for each global region in the coding target image (S14).

Next, the global motion vector calculation unit 68 calculates the global motion vector GMV for each global region (S16).

The local motion vector difference coding unit 72 calculates the local motion vector differences ΔLMV for each global region, and performs coding thereof (S18). The global motion vector difference coding unit 74 calculates the global motion vector difference ΔGMV for each global region, and performs coding thereof (S20).

FIGS. 4A through 4C are diagrams for describing an example of the global region. In the example shown in FIG. 4A, the region setting unit 64 sets a first global region 211 and a second global region 212 in a coding target image 200. The global motion vector calculation unit 68 obtains a first global motion vector GMV1 for the first global region 211, and a second global motion vector GMV2 for the second global region 212. In this example, there is no region for which the global motion vector is to be obtained, in the back ground region other than the first global region 211 and the second global region 212.

In the example shown in FIG. 4A, in a case of coding the local motion vectors LMV within the first global region 211, the local motion vector difference coding unit 72 obtains ΔLMV=LMV−GMV1, which is the difference between the local motion vector LMV and the first global motion vector GMV1, for each macro block, and performs coding thereof. In the same way, in a case of coding the local motion vectors LMV within the second global region 212, the local motion vector difference coding unit 72 obtains ΔLMV=LMV−GMV2, which is the difference between the local motion vector LMV and the second global motion vector GMV2, for each macro block, and performs coding thereof.

In the example shown in FIG. 4A, the global motion vector GMV is not obtained for any region in the background region other than the first global region 211 and the second global region 212. Accordingly, in a case of coding the local motion vectors in the background region, the local motion vector difference coding unit 72 performs coding of each local motion vector LMV without calculating the difference between the local motion vector LMV and the global motion vector GMV, i.e., without performing computation before the coding.

In the example shown in FIG. 4B, the region setting unit 64 sets the background region other than the first global region 211 and the second global region 212 to be a third global region 210, unlike the example shown in FIG. 4A. The global region vector calculation unit 68 obtains a third global motion vector GMV0 for the third global region 210. In a case of coding the local motion vectors LMV within the third global region 210, the local motion vector difference coding unit 72 calculates ΔLMV=LMV−GMV0, which is the difference between the local motion vector LMV and the third global motion vector GMV0, for each macro block, and performs coding thereof.

FIG. 4C shows an example in which there is an inclusion relation among multiple global regions in the coding target image 200. In this example, the second global region 212 is included in the first global region 211. Furthermore, the entire areas of the first global region 211 and the second global region 212 are included in the third global region 210.

In a case of coding the local motion vectors LMV within the second global region 212, the local motion vector difference coding unit 72 performs coding of the difference between the second global motion vector GMV2 and the local motion vector LMV for each macro block. In a case of coding the local motion vectors LMV in a region which is inside the first global region 211 and is outside the second global region 212, the local motion vector difference coding unit 72 performs coding of the difference between the first global motion vector GMV1 and the local motion vector LMV for each macro block. In a case of coding the local motion vectors LMV in a region which is inside the third global region 210 and is outside the first global region 211, the local motion vector difference coding unit 72 performs coding of the difference between the third global motion vector GMV0 and the local motion vector LMV for each macro block.

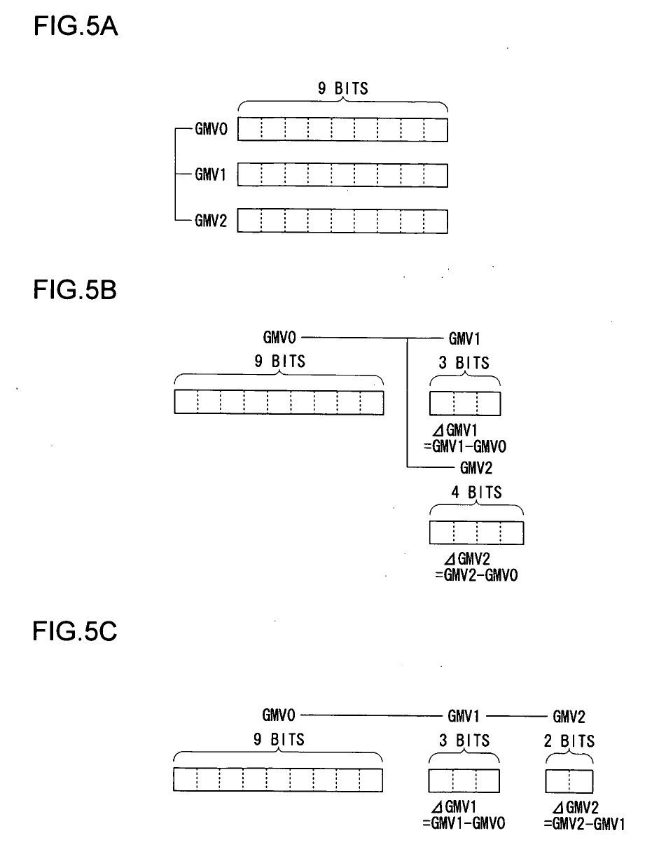

FIGS. 5A through 5C are diagrams for describing examples of the calculation of the global motion vector difference performed by the global vector difference coding unit 74. Here, description will be made regarding examples in which three global regions are set as shown in FIG. 4B or 4C, the three global motion vectors GMV0, GMV1, and GMV2 are obtained for the three respective global regions, and the three global motion vectors GMV0, GMV1, and CMV2 are coded.

FIG. 5A shows an arrangement in which the three global motion vectors GMV0, GMV1, and GMV2, are handled without involving any hierarchical structure. With such an arrangement, the global motion vector difference coding unit 74 handles all the three global motion vectors GMV0, GMV1, and GMV2 as a set of reference global motion vectors. Specifically, the global motion vector difference coding unit 74 performs coding of the 9-bit global motion vectors GMV0, GMV1, and GMV2 without calculating the global motion vector difference, i.e., without performing any calculation before the coding, and outputs the coded global motion vectors.

FIG. 5B shows an arrangement in which the three global motion vectors GMV0, GMV1, and GMV2 are handled in a hierarchical structure. With such an arrangement, GMV0 serves as a global motion vector at a higher hierarchical level. On the other hand, each of GMV1 and GMV2 serves as a global motion vector at a hierarchical level immediately lower than that of GMV0. With such an arrangement, the global vector difference coding unit 74 performs coding of each of the global motion vectors GMV1 and GMV2 at the lower hierarchical level with the global motion vector GMV0 at the higher hierarchical level as a reference global motion vector. Specifically, the global vector difference coding unit 74 performs coding of ΔGMV1=GMV1−GMV0, which is the difference between the global motion vector GMV1 and the reference global motion vector GMV0, and ΔGMV2=GMV2−GMV0, which is the difference between the global motion vector GMV2 and the reference global motion vector GMV0. Here, each of the global motion vectors GMV1 and GMV2 at the lower hierarchical level has a 9-bit original coding amount. With such an arrangement, the global motion vectors GMV1 and GMV2 are represented by reduced coding amounts, i.e., a 3-bit coding amount and the 4-bit coding amount, respectively, by calculating the difference between the global motion vector GMV1 and the higher hierarchical level global motion vector GMV0, and calculating the difference between the global motion vector GMV2 and the higher hierarchical level global motion vector GMV0.

FIG. 5C shows an arrangement in which the three global motion vectors GMV0, GMV1, and GMV2 are handled using another hierarchical structure. With such an arrangement, GMV0 serves as the global motion vector at the highest hierarchical level. GMV1 serves as the global motion vector at the next lower hierarchical level than that of GMV0, and GMV2 serves as the global motion vector at next lower hierarchical level than that of GMV1. With such an arrangement, the global motion vector difference coding unit 74 performs coding of the global motion vectors GMV1 at the second hierarchical level with the global motion vector GMV0 at the first hierarchical level as a reference global motion vector. Specifically, the global vector difference coding unit 74 performs coding of ΔGMV1=GMV1−GMV0, which is the difference between the global motion vector GMV1 and the reference global motion vector GMV0. Here, the second hierarchical level global motion vector GMV1 has a 9-bit original coding amount. With such an arrangement, the global motion vector GMV1 is represented by a reduced coding amount, i.e., a 3-bit coding amount, by calculating the difference between the global motion vector GMV1 and the first hierarchical level global motion vector GMV0.

Then, the global vector difference coding unit 74 performs coding of ΔGMV2=GMV2−GMV1, which is the difference between the third hierarchical level global motion vector GMV2 and the second hierarchical level global motion vector GMV1. Here, the third hierarchical level global motion vector GMV2 has a 9-bit original coding amount. With such an arrangement, the global motion vector GMV2 is represented by the reduced coding amount, i.e., a 2-bit coding amount, by calculating the difference between the global motion vector GMV2 and the second hierarchical level global motion vector GMV1.

With either of the arrangements shown in FIG. 5B or FIG. 5C, the global motion vector difference coding unit 74 outputs the reference global motion vector GMV0 and the two global motion vector differences ΔGMV1 and ΔGMV2, as the motion vector information. In this stage, the information that indicates the hierarchical structure used for handling the three global motion vectors GMV0, GMV1, and GMV2, is appended as a part of the motion vector information.

As described above with reference to the examples shown in FIGS. 5B and 5C, an arrangement may be made in which the global motion vectors are handled in a hierarchical structure as appropriate. With such an arrangement, each of the global motion vectors is represented by a reduced coding amount by calculating the difference between the global motion vector and another global motion vector at an adjacent hierarchical level. Description has been made in the above examples regarding an arrangement in which coding is performed for the difference between the global motion vector at a lower hierarchical level and the global motion vector at a higher hierarchical level with the global motion vector at the higher hierarchical level as a reference. Also, an arrangement may be made in which coding is performed for the difference between the global motion vector at a lower hierarchical level and the global motion vector at a higher hierarchical level with the global motion vector at the lower hierarchical level as a reference.

The hierarchical structure for the global motion vectors may be determined regardless of the inclusion relation among the global regions. Also, the hierarchical structure may be determined based upon the inclusion relation among the global regions.

For example, let us consider a case in which the first global region 211 and the second global region 212 are included within the third global region 210 as shown in FIG. 4B. In this case, the global motion vector difference coding unit 74 creates a hierarchical structure in which the global motion vector GMV0 of the third global region 210 is set to a higher hierarchical level, and the global motion vectors GMV1 and GMV2 of the first and second global regions 211 and 212 are set to the immediately lower hierarchical level, based upon the inclusion relation among these global regions, as shown in FIG. 5B. The global motion vector difference coding unit 74 performs coding of the global motion vector difference using the hierarchical structure thus created.

Next, let us say that there is an inclusion relation in which the second global region 212 is included within the first global region 211, and the entire areas of the first global region 211 and the second global region 212 are included within the third global region 210. In this case, the global motion vector difference coding unit 74 creates a hierarchical structure in which the global motion vector GMV0 of the third global region 210 is set to the highest hierarchical level, the global motion vector GMV1 of the first global region 211 is set to a second hierarchical level, and the global motion vector GMV2 of the second global region 212 is set to a third hierarchical level. The global motion vector difference coding unit 74 performs coding of the global motion vector difference using the hierarchical structure thus created.

With such an arrangement in which the hierarchical structure for the global motion vectors is created just in accordance with the inclusion relation among the global regions set by the region setting unit 64, and the information with respect to the inclusion relation among the global regions is included as a part of the motion vector information, there is no need to provide the information with respect to the hierarchical structure for the global motion vectors in the form of additional information. Such an arrangement reduces the amount of data in the header information.

Also, let us consider a case in which the inclusion relation among the global regions reflects the relative difference in the motion amount in the image such as the difference in the motion amount between the region around the center and the back ground region in the image, the difference in the motion amount between the region of a particular object and the background region other than the region of the particular object, and so forth. In this case, with such an arrangement in which the hierarchical structure for the global motion vectors is created such that it just reflects the inclusion relation among the global regions, and the global motion vector difference is obtained according to the hierarchical structure thus created, it is expected in general that the global motion vector difference can be represented with a fewer number of bits.

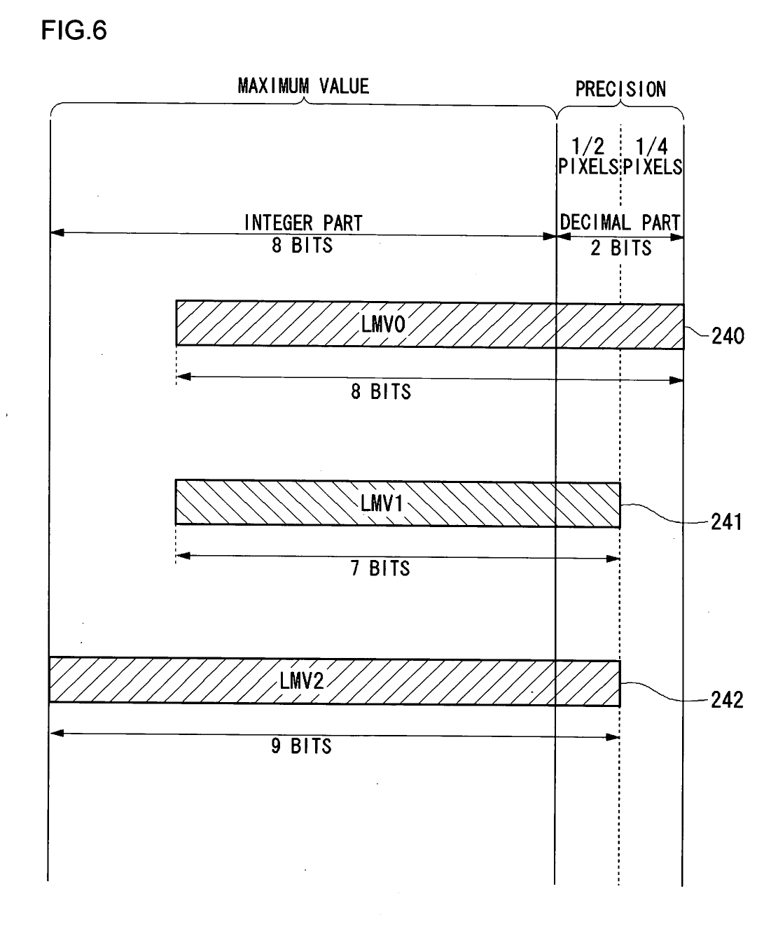

FIG. 6 is a diagram for describing the number of bits of the local motion vector LMV, which is adjusted by the bit number adjustment unit 62.

As an example, the x and y coordinate values of the local motion vector LMV are represented by data formed of the 8-bit integer part and the 2-bit decimal part, i.e., a total of 10 bits. The digit of the integer part is determined corresponding to the maximum value possible for the local motion vector LMV. On the other hand, the digit of the decimal part is determined corresponding to the pixel precision of the motion compensation. Specifically, a motion vector represented with ½ pixel precision requires the information with a 1 bit decimal part. On the other hand, the motion vector represented with a ¼ pixel precision requires the information with a 2 bit decimal part.

Now, let us consider a case in which the global regions corresponding to the three global motion vectors GMV0, GMV1, and GMV2 are set, as shown in FIG. 4B or FIG. 4C. Description will be made regarding an example of adjustment of the number of bits of the local motion vector LMV which is obtained for each macro block within each global region.

Here, the local motion vectors within the first, second, and third global regions, for which the first global motion vector GMV1, the second global motion vector GMV2, and the third global motion vector GMV0, are obtained, will be referred to as “first local motion vector LMV1”, “second local motion vector LMV2”, and “third local motion vector LMV0”, respectively.

As denoted by reference numeral 240, the third local motion vector LMV0 is represented by data with a 2 bit decimal part and a 6 bit integer part, i.e., with a total of 8 bits. In this case, the third local motion vector LMV0 is represented with a ¼ pixel precision. The maximum value of the positive integer which is represented by 6 bits of data is 26=64. In this case, the maximum value possible for each coordinate value that represents the motion vector is ±32 pixels. Accordingly, a region with a ±32 pixel motion search range and with a ¼ pixel motion precision is preferably selected as the third global region. Examples of the regions which are preferably selected as the third global region include a region occupied by an object such as a human figure, which moves at a fine pitch that requires high-precision motion compensation.

As denoted by reference numeral 241, the first local motion vector LMV1 is represented by data with a 1 bit decimal part and a 6 bit integer part, i.e., with a total of 7 bits. In this case, the first local motion vector LMV1 is represented with a ½ pixel precision. The range of each coordinate value which represents the motion vector is ±32 pixels. Accordingly, a region with a ±32 pixel motion search range, and with a ½ pixel motion precision, is preferably selected as the first global region. Examples of the regions which are preferably selected as the first global region include the background region which exhibits a relatively small amount of movement, and thus does not require high-precision motion compensation.

As denoted by reference numeral 242, the second local motion vector LMV2 is represented by data with a 1 bit decimal part and an 8 bit integer part, i.e., with a total of 9 bits. In this case, the second local motion vector LMV2 is represented with a ½ pixel precision. The maximum value of the positive integer which is represented by 8 bits of data is 28=256. In this case, the maximum value possible for each coordinate value that represents the motion vector ±128 pixels. Accordingly, a region with a ±128 pixel motion search range, and with a ½ pixel motion precision, is preferably selected as the second global region. Examples of the regions which are preferably selected as the second global region include: the background region which exhibits a great amount of change; and the region occupied by an object which exhibits a great amount of movement.

At the time when the global regions are set by the region setting unit 64, the bit number adjustment unit 62 may set beforehand the size of the motion search range and the pixel precision of the motion compensation for each global region. With such an arrangement, the local motion vector detection unit 66 detects the local motion vectors within each global region after the numbers of bits of the local motion vectors have been determined.

The coding may be performed according to another procedure as follows. That is to say, an arrangement may be made in which the bit number adjustment unit 62 evaluates the size of the local motion vectors detected within each global region, and determines the number of bits necessary to represent the local motion vector within each global region. With such an arrangement, the number of bits of the local motion vector may be adjusted corresponding to the change in the motion over time.

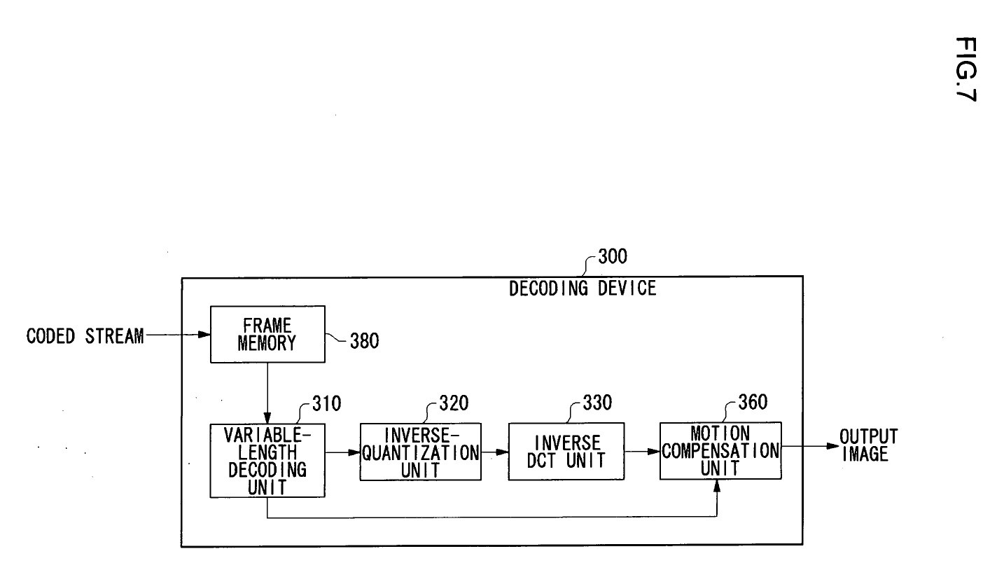

FIG. 7 is a configuration diagram which shows the decoding device 300 according to the embodiment 1. The functional block configuration can also be realized by hardware components alone, software components alone, or combinations thereof.

The decoding device 300 receives a coded stream, and decodes the coded stream, thereby creating an output image. The coded stream thus input is stored in frame memory 380.

A variable-length decoding unit 310 performs variable-length decoding of the coded stream stored in the frame memory 380, and transmits the decoded image data to an inverse-quantization unit 320. On the other hand, the variable-length decoding unit 310 transmits the decoded motion vector information to a motion compensation unit 360.

The inverse-quantization unit 320 performs inverse-quantization of the image data decoded by the variable-length decoding unit 310, and transmits the image data thus inverse-quantized to an inverse DCT unit 330. The image data inverse-quantized by the inverse quantized unit 320 is a DCT coefficient set. The inverse DCT unit 330 performs inverse discrete cosine transform (IDCT) for the DCT coefficient set inverse-quantized by the inverse quantization unit 320, thereby reconstructing the original image data. The image data reconstructed by the inverse DCT unit 330 is transmitted to the motion compensation unit 360.

The motion compensation unit 360 creates a predicted image based upon the motion vector information supplied from the variable-length decoding unit 310 using the prior or upcoming image frame as a reference image. Then, the motion compensation unit 360 reconstructs the original image data by making the sum of the predicted image and the subtraction image supplied from the inverse DCT unit 330, and outputs the original image data thus reconstructed.

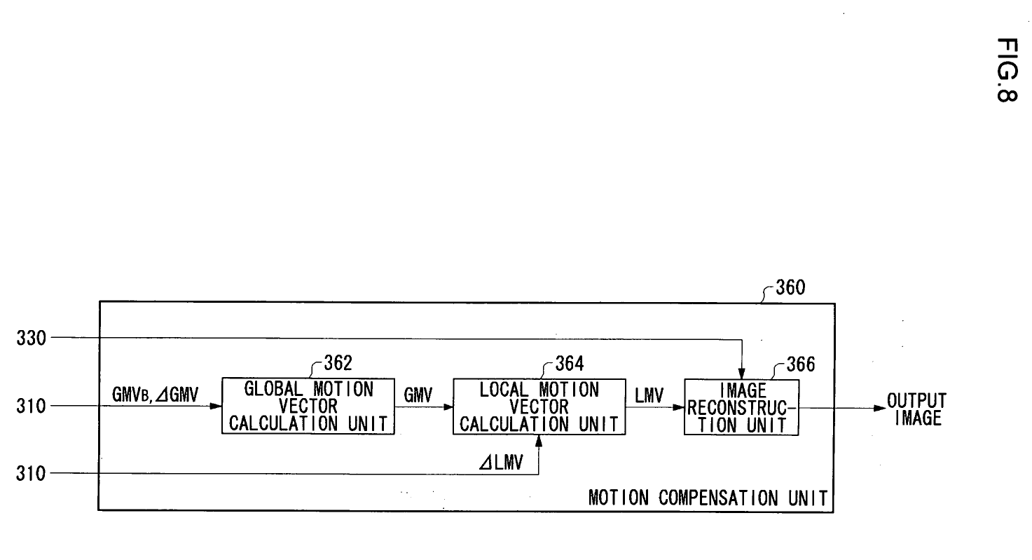

FIG. 8 is a diagram for describing the configuration of the motion compensation unit 360. The coded stream, which has been coded by the coding device 100 shown in FIG. 1, is input to the decoding device 300. The motion vector information, which is supplied to the motion compensation unit 360, includes: the reference global motion vector GMV_{B}; the global motion vector difference ΔGMV; and the local motion vector difference ΔLMV. The motion compensation unit 360 obtains the local motion vector LMV with reference to this motion vector information, and performs motion compensation. The motion compensation unit 360 performs the following motion compensation steps with reference to the motion compensation parameters such as the size of the motion search range for each global region, the pixel precision of the motion compensation, the maximum value possible for the local motion vector LMV for each global region, and so forth, which are supplied as a part of the motion vector information.

A global motion vector calculation unit 362 receives the reference global motion vector GMV_{B} and the global motion vector difference ΔGMV for each global region in the form of the input from the variable-length decoding unit 310, calculates the global motion vector GMV=ΔGMV+GMV_{B}, and transmits the global motion vector GMV to a local motion vector calculation unit 364.

The local motion vector calculation unit 364 receives the local motion vector difference ΔLMV in the form of the input from the variable-length decoding unit 310, and the global motion vector GMV for each global region in the form of the input from the global motion vector calculation unit 362. Then, the local motion vector calculation unit 364 calculates the local motion vector LMV=ΔLMV+GMV. The local motion vector calculation unit 364 transmits the local motion vectors LMV thus calculated for each global region, to an image reconstruction unit 366.

The image reconstruction unit 366 creates a predicted image using the reference image and the local motion vectors LMV each of which has been calculated for the corresponding macro block within each global region. Then, the image reconstruction unit 366 reconstructs the original image by calculating the sum of the subtraction image received from the inverse DCT unit 330 and the predicted image thus created, and outputs the original image thus reconstructed.

As described above, with the coding device 100 according to the embodiment 1, motion vectors are coded with the number of bits of the motion vectors adjusted for each region. Such an arrangement enables the required number of bits to be reduced for a region which does not require high precision or a great absolute value of the motion vector. This improves the coding efficiency of the motion vector.

With the present embodiment, the number of bits of the motion vector can be adjusted for each region. Such an arrangement allows the pixel precision to be increased for a region which exhibits fine-pitch motion. Also, such an arrangement allows the maximum size possible for the motion vector to be increased for a region which exhibits a great amount of motion. On the other hand, such an arrangement allows the pixel precision to be reduced for the region which exhibits coarse-pitch motion. Also, such an arrangement allows the maximum value possible for the motion vector to be reduced for a region which exhibits a small amount of motion. This enables the number of bits assigned to each region to be suitably adjusted according to the pitch and the amount of the motion in the region, or the precision of the motion compensation required for the region. This improves the compression efficiency of the moving image stream while improving the reconstructed image quality of the moving images.

Furthermore, with the present embodiment, before the coding of the motion vectors, the information with respect to the motion vector within a spatial region is represented by the difference between the motion vector and the global motion vector of this region. Such an arrangement enables the amount of data of the information with respect to the individual motion vectors to be reduced. This reduces the overall coding amount of the moving image stream, thereby improving the compression efficiency. Furthermore, with the present embodiment, the global motion vectors of the spatial regions are handled in a hierarchical structure, and coding is performed for the difference between the global motion vectors at different hierarchical levels. Such an arrangement enables the coding amount of the motion vector information to be further reduced.

On the other hand, with the decoding device 300 according to the embodiment 1, motion compensation is performed for each region based upon the corresponding motion vector acquired from a highly compressed moving image stream, which has been created by the coding device 100 by coding motion vectors with the number of bits adjusted for each region, thereby enabling high-quality moving images to be reconstructed. With such an arrangement, the motion vector is coded with the optimum number of bits for each region, thereby improving the motion compensation efficiency while maintaining the high precision of the motion compensation for each region.

Description has been made regarding the present invention with reference to the aforementioned embodiment. The above-described embodiment has been described for exemplary purposes only, and is by no means intended to be interpreted restrictively. Rather, it can be readily conceived by those skilled in this art that various modifications may be made by making various combinations of the aforementioned components or the aforementioned processing, which are also encompassed in the technical scope of the present invention.

Description has been made in the present embodiment regarding an arrangement in which the coding device 100 and the decoding device 300 perform coding and decoding of the moving images in accordance with the MPEG series standards (MPEG-1, MPEG-2, and MPEG-4), the H.26x series standards (H.261, H.262, and H.263), or the H.264/AVC standard. Also, the present invention may be applied to an arrangement in which coding and decoding are performed for moving images managed in a hierarchical manner having a temporal scalability. In particular, the present invention is effectively applied to an arrangement in which motion vectors are coded with the reduced coding amount using the MCTF technique.

Description has been made in the above embodiment 1 regarding an arrangement in which the bit number adjustment unit 62 adjusts the number of bits of the local motion vectors for each global region for which the global motion vector is obtained. The unit region for which the number of bits of the local motion vectors is adjusted is not restricted to such a global region. It is not essential for the motion compensation unit 60 to include a component for obtaining the global motion vectors and performing coding thereof. Also, the motion compensation unit 60 may include a single component alone for obtaining the local motion vectors and performing coding thereof.

Also, the coding device 100 may include a ROI region setting unit. Furthermore, an arrangement may be made in which the ROI (region of interest) is set on a moving image, and the bit number adjustment unit 62 adjusts the number of bits for each of the ROIs thus set.

With such an arrangement, the ROI may be selected by the user, by specifying a particular region. Also, a predetermined region such as the center region of the image may be set to be the ROI. Alternatively, an important region occupied by a human figure or a text may be automatically extracted. Also, an arrangement may be made in which the ROI is automatically selected for each frame by tracing the movement of a particular object or the like in the moving image.

Let us consider a case in which the priority is set for each of multiple ROIs. In this case, the bit number adjustment unit 62 may adjust the number of bits of the local motion vectors within each ROI according to the priority. With such an arrangement, each ROI is coded such that it can be reproduced with the image quality corresponding to its priority. Furthermore, an arrangement may be made in which the number of bits of the local motion vector is increased so as to increase the motion search range or the pixel precision of the motion compensation, according to the increase in the priority of the ROI. Such an arrangement further improves the image quality of the ROIs reproduced by the motion compensation.

### Embodiment 2

Background of this Embodiment

The rapid development of broadband networks has increased consumer expectations for services that provide high-quality moving images. On the other hand, large capacity storage media such as DVD and so forth are used for storing high-quality moving images. This increases the segment of users who enjoy high-quality images. A compression coding method is an indispensable technique for transmission of moving images via a communication line, and storing the moving images in a storage medium. Examples of international standards of moving image compression coding techniques include the MPEG-4 standard, and the H.264/AVC standard. Furthermore, the SVC (Scalable Vide Coding) technique is known, which is a next-generation image compression technique that includes both high quality image streaming and low quality image streaming functions.

Streaming distribution of high-resolution moving images without taking up most of the communication bandwidth, and storage of such high-resolution moving images in a recording medium having a limited storage capacity, require an increased compression ratio of a moving image stream. In order to improve the effects of the compression of moving images, motion compensated interframe prediction coding is performed. With motion compensated interframe prediction coding, a coding target frame is divided into blocks, and the motion between the target coding frame and a reference frame, which has already been coded, is predicted so as to detect a motion vector for each block, and the motion vector information is coded together with the subtraction image.

The H.264/AVC standard provides a function of adjusting the motion compensation block size, and a function of selecting the improved motion compensation pixel precision up to around ¼ pixel precision, thereby enabling finer prediction to be made for the motion compensation. Japanese Patent Application Laid-open Publication No. 11-46364 discloses a moving image coding technique in which motion vectors are obtained with multiple kinds of precision, and the precision is selected for each motion vector such that each set of the multiple blocks exhibits the smallest coding amount.

Summary of this Embodiment

In the development of SVC (Scalable Video Coding), which is a next-generation image compression technique, the MCTF (Motion Compensated Temporal Filtering) technique is being studied in order to improve temporal scalability. The MCTF technique is a technique that combines a time-base sub-band division technique and a motion compensation technique. With the MCTF technique, motion compensation is performed in a hierarchical manner, leading to significantly increased information with respect to the motion vectors. As described above, according to the recent trends, such a latest moving image coding technique requires the increased overall amount of data for the moving image stream due to the increased amount of information with respect to the motion vectors. This leads to a strong demand for a technique of reducing the coding amount due to the motion vector information.

The embodiment 2 has been made in view of the aforementioned problems. Accordingly, it is an object thereof to provide a moving image coding technique which offers a reduced amount of coding while maintaining the image quality.

An aspect of the embodiment 2 relates to a coding method. The coding method is a moving image coding method having a function of inter-picture prediction coding. The coding method comprises: a step for creating a motion vector of a coding target picture and a predicted image by performing motion vector searching based upon the coding target picture and a reference picture; and a step for quantizing a value corresponding to a subtraction image made between the coding target picture and the predicted image. With such an arrangement, in the step for creating the motion vector and the predicted image, motion vector searching is performed with a precision corresponding to the quantization scale used in the quantization step.

The term “picture” as used here represents a coding unit such as a frame, field, or VOP (Video Object Plane).

The quantization scale may be determined beforehand for a coding target moving image. Also, the quantization scale may be adjusted in a coding step in predetermined units that form the moving image. With the latter arrangement, the motion vector precision thus adjusted based upon the quantization scale may be applied to the subsequent motion vector searching. Alternatively, motion vector searching may be performed again for the same macro block with the motion vector precision adjusted based upon a subtraction image corresponding to this macro block.

Such an aspect of the embodiment 2 provides motion vector searching with a precision suitable for the quantization scale, thereby offering effective acquisition of coded data.

Such a method may further include a step for selecting a motion vector precision table from among multiple motion vector precision tables having different predetermined relations between the quantization scale and the motion vector precision based upon at least one of the predetermined moving image properties and the coding type. With such a method, in the step for creating the motion vector and the predicted image, motion vector searching is performed with a precision determined based upon the quantization scale with reference to the motion vector precision table.

With such an arrangement, the aforementioned motion vector precision tables may be stored in a readable storage device such as a RAM (Random Access Memory), ROM (Read Only Memory), etc., a recording medium, or the like. The aforementioned predetermined moving image properties may be one of the motion image profile, the image size, and so forth, or may be a combination thereof. The aforementioned coding type may be one of the picture type, the slice type, the macro block size, and so forth, or may be a combination thereof. Examples of the aforementioned multiple motion vector precision tables include: a table for greatly varying the motion vector precision according to the change in the quantization scale; a table for slightly varying the motion vector precision according to the change in the quantization scale; and a table for maintaining the motion vector precision at a constant value.

Such an aspect of the embodiment 2 enables the manner of adjusting the motion vector precision to be adjusted based upon the properties of the moving image, the coding type, etc.

Also, with the aforementioned method, a stream formed of moving images may include the motion vector precision tables. Also, this stream may include identification information for selecting a single motion vector precision table from among the multiple predetermined motion vector precision tables. With such an arrangement, in the step for creating the motion vector and the predicted image, motion vector searching is performed with a precision determined based upon the quantization scale with reference to the motion vector precision table in the same way as described above.

Such an arrangement enables the optimum adjustment of the motion vector precision to be made for each moving image.

Note that any combination of the aforementioned components or any manifestation of the embodiment 2 realized by modification of a method, device, system, computer program, and so forth, is effective as an aspect of the embodiment 2.

Detailed Description of this Embodiment

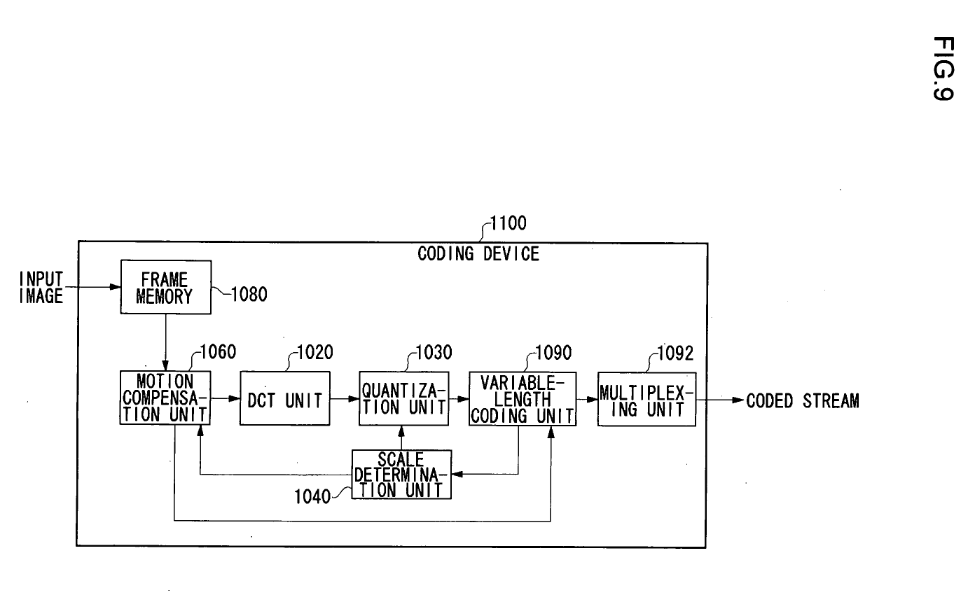

FIG. 9 is a configuration diagram which shows a coding device 1100 according to an embodiment 2. This configuration can be realized by hardware means, e.g., by actions of a CPU, memory, and other LSIs, of a computer, or by software means, e.g., by actions of a program having a function of image coding or the like, loaded into the memory. Here, the drawing shows a functional block configuration which is realized by cooperation between the hardware components and software components. It is needless to say that such a functional block configuration can be realized by hardware components alone, software components alone, or various combinations thereof, which can be readily conceived by those skilled in this art.

The coding device 1100 according to the present embodiment performs coding of moving images according to the MPEG (Moving Picture Experts Group) series standards (MPEG-1, MPEG-2, and MPEG-4) standardized by the international standardization organization ISO (International Organization for Standardization)/IEC (International Electrotechnical Commission), the H.26x series standards (H.261, H.262, and H.263) standardized by the international standardization organization with respect to electric communication ITU-T (International Telecommunication Union-Telecommunication Standardization Sector), or the H.264/AVC standard which is the newest moving image compression coding standard jointly standardized by both the aforementioned standardization organizations (these organizations have advised that this H.264/AVC standard should be referred to as “MPEG-4 Part 10: Advanced Video Coding” and “H.264”, respectively).

With the MPEG series standards, in a case of coding an image frame in the intra-frame coding mode, the image frame to be coded is referred to as “I (Intra) frame”. In a case of coding an image frame with a prior frame as a reference image, i.e., in the forward interframe prediction coding mode, the image frame to be coded is referred to as “P (Predictive) frame”. In a case of coding an image frame with a prior frame and an upcoming frame as reference images, i.e., in the bi-directional interframe prediction coding mode, the image frame to be coded is referred to as “B frame”.

On the other hand, with the H.264/AVC standard, image coding is performed using reference images regardless of the time at which the reference images have been acquired. For example, image coding may be made with two prior image frames as reference images. Also, image coding may be made with two upcoming image frames as reference images. Furthermore, the number of the image frames used as the reference images is not restricted in particular. For example, image coding may be made with three or more image frames as the reference images. Note that, with the MPEG-1, MPEG-2, and MPEG-4 standards, the term “B frame” represents the bi-directional prediction frame. On the other hand, with the H.264/AVC standard, the time at which the reference image is acquired is not restricted in particular. Accordingly, the term “B frame” represents the bi-predictive prediction frame.

While description will be made in the embodiment 2 regarding an arrangement in which coding is performed in units of frames, coding may also be performed in units of fields. Also, coding may be performed in units of VOP stipulated in the MPEG-4. In a case of dividing one frame horizontally into slices, and performing prediction coding in units of the slices thus divided, these slices are referred to as “I slice”, “P slice”, and “B slice”, corresponding to the “I frame”, “P frame”, and “B frame”.

The coding device 1100 receives the input moving images in units of frames in the form of an input stream, performs coding of the moving images, and outputs a coded stream. The moving image frames thus input are stored in frame memory 1080.

A motion compensation unit 1060 performs motion compensation for each macro block of a P frame or B frame using a prior or upcoming image frame stored in the frame memory 1080 as a reference image, thereby creating the motion vector and the predicted image. The motion compensation unit 1060 makes a subtraction between the image of the P frame or B frame to be coded and the predicted image, and supplies the subtraction image to a DCT unit 1020. Furthermore, the motion compensation unit 1060 supplies the coded motion vector to a variable-length coding unit 1090.

Description has been made regarding coding processing for a P frame or B frame, in which the motion compensation unit 1060 operates as described above. On the other hand, in a case of coding processing for an I frame, the I frame subjected to intra-frame prediction is supplied to the DCT unit 1020 without involving the motion compensation unit 1060. Note that this coding processing is not shown in the drawings.

The motion vector is a vector which represents the motion of one of the macro blocks into which a coding target frame is divided in units of a predetermined number of pixels. The motion vector is obtained for each macro block by searching the reference image for a predicted macro block which exhibits the smallest difference in comparison to the target macro block. Specifically, each motion vector is detected by searching the reference image for a reference macro block which matches the target macro block in units of pixels, or in units of fractions of a pixel. The unit used for searching for the motion vector will be referred to as “motion vector precision” hereafter. In the embodiment 2, the motion vector precision is determined based upon the quantization scale described later.

The DCT unit 1020 performs discrete cosine transform (DCT) for the image supplied from the motion compensation unit 1060, and transmits the DCT coefficients thus obtained to a quantization unit 1030.

The quantization unit 1030 performs quantization of the DCT coefficients, and transmits the quantized DCT coefficients to a variable-length coding unit 1090. The variable-length coding unit 1090 performs variable-length coding of the quantized DCT coefficients of the subtraction image and the motion vector supplied from the motion compensation unit 1060, and transmits the coded data to a multiplexing unit 1092. The multiplexing unit 1092 performs multiplexing of the coded DCT coefficients and the coded motion vector supplied from the variable-length coding unit 1090, thereby creating a coded stream. The multiplexing unit 1092 creates a coded stream while sorting the coded frames in order of time.

On the other hand, the quantization scale used for quantizing the DCT coefficients at the quantization unit 1030 is adjusted as follows, such that the coding amount of the coded DCT coefficients is approximately uniform over the coded stream. First, the coding amount of the DCT coefficients coded by the variable-length coding unit 1090 is supplied to a scale determination unit 1040. The scale determination unit 1040 determines the quantization scale such that the coding amount is approximately uniform based upon the coding amount thus received, and transmits the quantization scale to the quantization unit 1030. Specifically, in a case that the coding amount is large, the scale determination unit 1040 increases the quantization scale. On the other hand, in a case that the coding amount is small, the scale determination unit 1040 reduces the quantization scale. In the processing thereafter for the macro block, the quantization unit 1030 quantizes the DCT coefficients with the quantization scale received from the scale determination unit 1040. Also, the quantization scale determined by the scale determination unit 1040 is supplied to the motion compensation unit 1060. The motion vector precision is adjusted based upon the quantization scale.

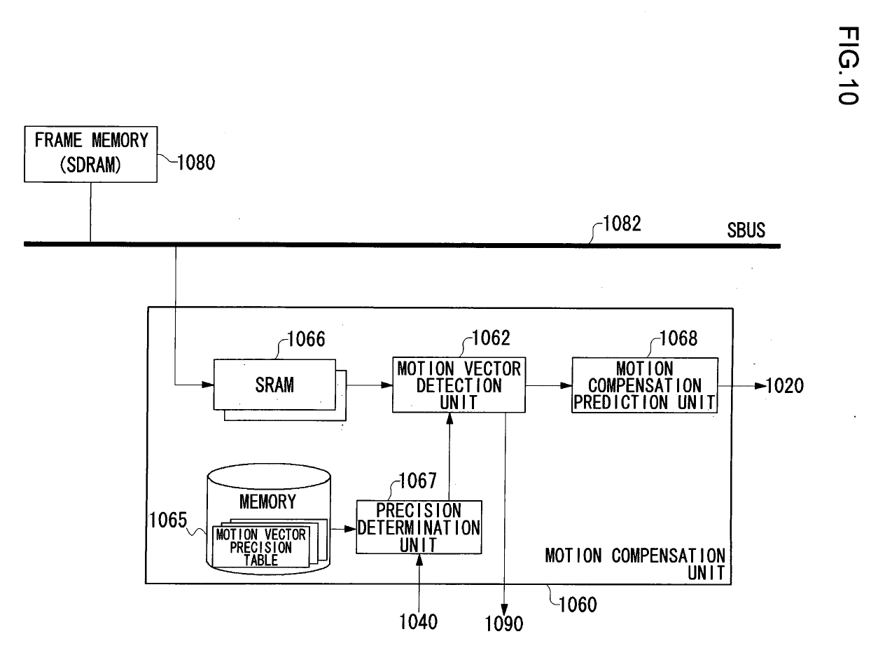

FIG. 10 shows the configuration of the motion compensation unit 1060. Frame memory 1080 and the motion compensation unit 1060 are connected through an SBUS 1082. The motion compensation unit 1060 requests the frame memory 1080 to supply data by specifying the address of the data. Then, the motion compensation unit 1060 receives the data transmitted from the frame memory 1080 via the SBUS 1082.

The motion compensation unit 1060 includes SRAM 1066, a motion vector detection unit 1062, a precision determination unit 1067, memory 1065, and a motion compensation prediction unit 1068. The motion vector detection unit 1062 extracts the pixel data within a predetermined search region, which corresponds to the target macro block, from the reference image held by the frame memory 1080, and transmits the extracted pixel data to the SRAM 1066. Then, the motion vector detection unit 1062 performs motion vector search with reference to the pixel data thus transmitted. The motion vector thus detected is supplied to the motion compensation prediction unit 1068 and the variable-length coding unit 1090.

The precision determination unit 1067 acquires the motion vector precision corresponding to the adjusted quantization scale supplied from the scale determination unit 1040, with reference to motion vector precision table stored in the memory 1065 with this quantization scale as a parameter. The motion vector precision table is a table which indicates the relation between the quantization scale and the motion vector precision, which will be described later in detail. The precision determination unit 1067 supplies the motion vector precision thus obtained to the motion vector detection unit 1062. In the subsequent motion vector search, the motion vector detection unit 1062 searches for the motion vectors for each macro block with the motion vector precision supplied from the precision determination unit 1067.

The motion compensation prediction unit 1068 performs motion compensation for the target macro block using the local motion vector, thereby creating a predicted image. Furthermore, the motion compensation prediction unit 1068 creates a subtraction image by making a subtraction between the coding target image and the predicted image, and outputs the subtraction image to the DCT unit 1020.

Next, description will be made regarding the motion vector precision corresponding to the quantization scale. Note that the data obtained by quantizing the DCT coefficients of the subtraction image will be referred to as “subtraction image values”. The data obtained by performing variable-length coding of the subtraction image value will be referred to as “subtraction image code”-hereafter. The data obtained by performing variable-length coding of the motion vector will be referred to as “motion vector code” hereafter.

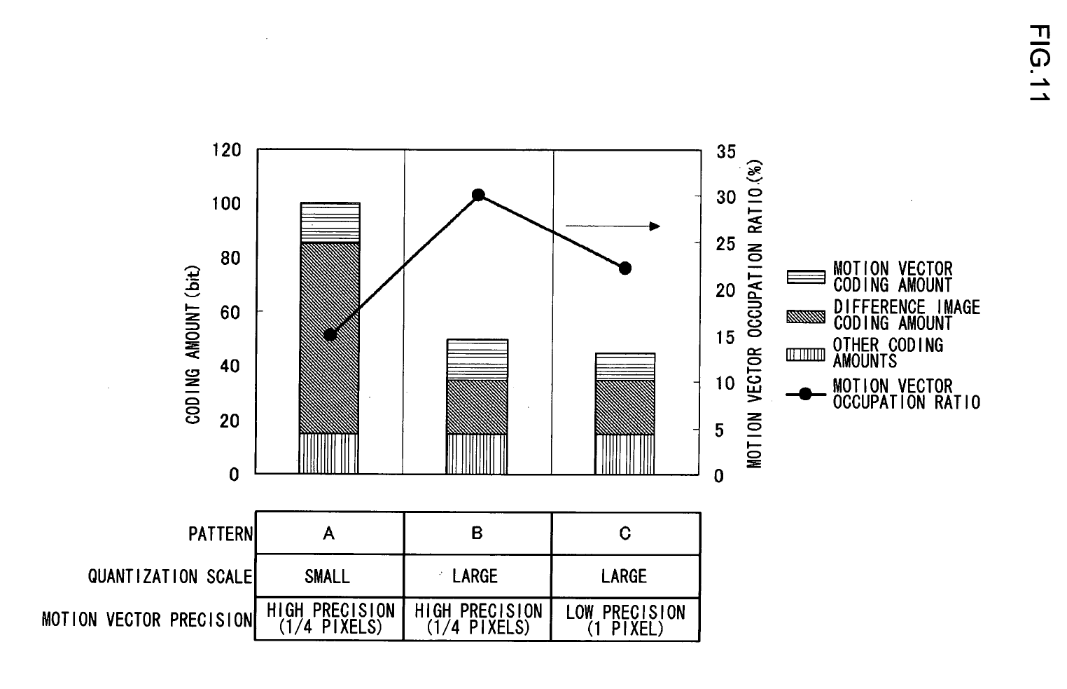

FIG. 11 is a diagram which shows examples of the coding amounts which vary according to difference in the size of the quantization scale and the motion vector precision thereamong. This drawing shows the classified coding amounts, i.e., the difference image coding amount, the motion vector coding amount, and the other coding amount, for each of three patterns. The pattern A represents a case in which the quantization scale is small, and the motion vector precision is high, i.e., ¼-pixel precision. The pattern B represents a case in which the quantization scale is large, and the motion vector precision is high, i.e., the same as that of pattern A. The pattern C represents a case in which the quantization scale is large, and the motion vector precision is small, i.e., single-pixel precision.

Let us consider a case in which the quantization scale is increased while the motion vector precision is maintained, such as a case of the pattern B as compared to the pattern A. In this case, the amount of data of the quantized subtraction image values is reduced, and accordingly, the coding amount of the subtraction image codes is reduced. On the other hand, the coding amount of the motion vector code does not change. Accordingly, the code occupation ratio for the motion vector, i.e., the ratio of the amount of the motion vector code as to the overall coding amount is increased.

Let us consider a case in which the motion vector precision is reduced while maintaining the quantization scale, such as a case of the pattern C as compared with the pattern B. In this case, the coding amount of the motion vector code is reduced, leading to reduction in the motion vector occupation ratio. Accordingly, the code occupation ratio for the motion vector of the pattern A is closer to that of the pattern C than that of the pattern B.

Description will be made below, giving consideration to the code occupation ratio for the motion vector. In general, the increased precision of the motion vector reduces the subtraction image values, leading to the reduced coding amount of the subtraction image code. Let us consider a case in which the quantization scale is increased while the motion vector precision at a high level is maintained, such as a case of transition from the pattern A to the pattern B. In this case, the truncated portions of the subtraction image values are increased. Accordingly, such a case reduces the advantage of reducing the coding amount while maintaining the image quality that is produced by high-precision motion vectors. On the other hand, let us consider a case of reducing the motion vector precision while maintaining the quantization scale at a large level, such as a case of transition from the pattern B to the pattern C. In this case, the increased subtraction image values due to the reduced motion vector precision is absorbed by quantization with a large quantization scale while the image quality is maintained at approximately the same level. On the other hand, let us consider a case of increasing the motion vector precision while maintaining the quantization scale at a large level, such as a case of transition from the pattern C to the pattern B. In this case, the coding amount of the motion vector code is increased, leading to an increased overall coding amount. Accordingly, with the present embodiment, in a case that the quantization scale is large, and the coding amount of the subtraction image codes is small, the motion vector precision is reduced, thereby providing effective coding with a reduced coding amount. In other words, with the present embodiment, coding is performed while the code occupation ratio for the motion vector is maintained at approximately the same level, thereby providing effective coding with a reduced coding amount.

Next, description will be made regarding the motion vector precision table which is referred to by the precision determination unit 1067 in determining the motion vector precision. The motion vector precision table is a table which indicates the relation between the quantization scale and the motion vector precision. Specifically, the memory 1065 stores the information stipulated in the standard or specification beforehand in the form of a table. Furthermore, an arrangement may be made in which the memory 1065 stores multiple tables having different relations, and a suitable one is selected from among these tables based upon the predetermined properties of the image and the coding processing. Examples of the predetermined properties include: the profile of the image; the size of the image; the frame type; the slice type; the size of the macro block; etc. Also, examples of the candidate tables include a table in which the motion vector precision is a constant.

The motion vector precision table may be included in the input stream of moving images. In this case, the input stream may include the motion vector precision table in its entirety. Also, an arrangement may be made in which the memory 1065 or the like stores the motion vector precision tables beforehand, and the input stream includes the identification information which indicates one of these motion vector precision tables. With such an arrangement, the precision determination unit 1067 makes reference to the motion vector precision table specified by the identification information. With such an arrangement, unlike an arrangement as described above, the motion vector precision table suitable for the moving image can be specified as appropriate according to the circumstances without the need to select the precision determination table based upon the properties of the images or the like. Also, an arrangement may be made in which the input stream of moving images includes multiple motion vector precision tables having different relations, and a suitable one is selected from among these multiple tables based upon the aforementioned predetermined properties of the images and the coding processing, and the identification information included in the input stream. Such an arrangement allows the optimum precision table to be acquired according to the circumstances. Furthermore, with such an arrangement, there is no need to store the information which has been stipulated in the standard or the specification, in the memory 1065 beforehand, thereby providing the flexibility to modify the specification.

Let us consider an arrangement in which the input stream includes the motion vector precision table in its entirety. With such an arrangement, at the time of creating the input stream, a suitable one may be selected from among multiple tables which have been defined beforehand. Alternately, the optimum table may be created for each moving image. A single motion vector precision table may be defined for each input stream. Also, the motion vector precision table may be defined in finer units. Examples of such units include: a single-frame unit; a multiple-frame unit; a single-slice unit; a multiple-slice unit; a single-macro-block unit; a multiple-macro-block unit; etc. Also, the motion vector precision table may be defined at a common parameter setting section which is used for multiple frames or multiple slices in the input stream.

Examples of motion vector precision tables are shown below. Note that the present embodiment 2 is not restricted to such examples. In these examples, the quantization scales are classified into relative sizes, e.g., “large” ad “small”, or “large”, “medium”, and “small”. Also, it is needless to say that the quantization scales may be classified according to absolute values. Furthermore, the absolute values used for classifying the quantization scales may be determined for each input moving image as appropriate.

Tables 1 through 3 shows three examples in which only a single table is defined independent of the properties of the image or the like.

TABLE 1

QUANTIZATION SCALE

| | SMALL | LARGE |
|---|---|---|
| MOTION VECTOR PRECISION | ¼ PIXELS | 1 PIXEL |

TABLE 2

| | QUANTIZATION SCALE | | |
|---|---|---|---|
| | SMALL | MEDIUM | LARGE |
| MOTION VECTOR | ¼ PIXELS | ½ PIXELS | 1 PIXEL |
| PRECISION | | | |

TABLE 3

QUANTIZATION SCALE

| | SMALL | LARGE |
|---|---|---|
| MOTION VECTOR PRECISION | ¼ PIXELS | ½ PIXELS |

As described above, coding using a large quantization scale reduces the advantage in increasing the motion vector precision. Accordingly, in this case, the motion vector precision is reduced so as to reduce the coding amount of the motion vector code. Let us consider a case in which the properties of the input moving images exhibit a particular tendency. In this case, the motion vector precision table may be determined giving consideration to the properties of the input moving images. Alternatively, the motion vector precision table may be determined giving consideration to the hardware configuration.

Tables 4 and 5 show examples of the motion vector precision tables which are used as candidates from which a suitable one is selected based upon the image size. Specifically, Table 4 shows a motion vector precision table which is selected for a moving image having an image size smaller than a predetermined reference value. Table 5 shows a motion vector precision table which is selected for a moving image having an image size equal to or greater than the predetermined reference value. Description has been made regarding an arrangement in which two motion vector precision tables are defined based upon the image size. Also, three or more motion vector precision tables may be defined based upon the image size.

TABLE 4

QUANTIZATION SCALE

| | SMALL | LARGE |
|---|---|---|
| MOTION VECTOR PRECISION | ¼ PIXELS | ¼ PIXELS |

TABLE 5

QUANTIZATION SCALE

| | SMALL | LARGE |
|---|---|---|
| MOTION VECTOR PRECISION | ¼ PIXELS | 1 PIXEL |

Let us consider a case in which a moving image having a large image size is coded with a reduced motion vector precision while the quantization scale is maintained at a high level. In general, the increased image size leads to the increased similarity between adjacent pixels. The reduced motion vector precision in such a case does not lead to the increased coding amount of the subtraction image code. Accordingly, with the present embodiment, in a case of coding a large-size moving image with a large quantization scale, the motion vector precision is reduced as shown in Table 5, thereby reducing the coding amount of the motion vector code. In a case of coding a moving image having a small image size, and thus, in a case that the level of similarity between adjacent pixels is low, the motion vector precision is fixed to a constant high precision value, as shown in Table 4.

Tables 6 and 7 show examples of the motion vector precision tables which are used as candidates from which a suitable one is selected based upon the image profile. Here, multiple image profiles are prepared for use in various situations. For example, there are three image profiles prepared for the H.264/AVC standard, i.e., a baseline profile to support real-time processing and bi-directional communication, a main profile to support broadcasting and storage media; and an extended profile to support streaming. Specifically, Table 6 shows a motion vector precision table which is selected for a moving image having the profile that supports broadcasting and storage media. Table 7 shows a motion vector precision table which is selected for a moving image having the profile that supports real-time processing and bi-directional communication.

TABLE 6

QUANTIZATION SCALE

| | SMALL | LARGE |
|---|---|---|
| MOTION VECTOR PRECISION | ¼ PIXELS | ½ PIXELS |

TABLE 7

QUANTIZATION SCALE

| | SMALL | LARGE |
|---|---|---|
| MOTION VECTOR PRECISION | ½ PIXELS | 1 PIXEL |

In a case that the coding requires real-time processing speed, the costs of the resources such as the amount of hardware, processing time, and so forth, which can be used for calculating motion vectors, are greatly restrictive. Accordingly, as shown in Table 7, the motion vector precision is reduced over the ranges of all the quantization scales, thereby giving priority to the coding efficiency, as compared with the motion vector precision table shown in Table 6, which is used for the coding that does not require real-time processing speed.

Tables 8 and 9 show examples of the motion vector precision tables which are used as candidates from which a suitable one is selected based upon the frame type or the slice type. Specifically, Table 8 shows a motion vector precision table which is selected for the P frame or the P slice. Table 9 shows a motion vector precision table which is selected for the B frame or the B slice.

TABLE 8

QUANTIZATION SCALE

| | SMALL | LARGE |
|---|---|---|
| MOTION VECTOR PRECISION | ¼ PIXELS | ¼ PIXELS |

TABLE 9

QUANTIZATION SCALE

| | SMALL | LARGE |
|---|---|---|
| MOTION VECTOR PRECISION | ¼ PIXELS | ½ PIXELS |

The B frame is coded with a prior frame and an upcoming frame as reference images. The coding of the B frame requires twice the number of motion vectors required for the P frame which is coded with only a prior frame as a reference image. Accordingly, the coding of the B frame requires a larger amount of motion vector code than that required for the P frame. The same can be said of the relation between the B slice and the P slice. Therefore, in a case of the coding of a B frame or a B slice with a large quantization scale, the motion vector precision is reduced so as to further reduce the coding amount of the motion vector code. In a case of the coding of a P frame or a P slice, the motion vector precision is fixed to a high precision value as shown in Table 8.

Tables 10 through 12 show examples of the motion vector precision tables which are used as candidates from which a suitable one is selected based upon the size of the macro block. Description will be made regarding an arrangement in which the sizes of the macro blocks are classified into “large”, “medium”, and “small”. For example, the 16×16 pixel macro block will be referred to as “large macro block”. The 16×8 pixel macro block, the 8×16 pixel macro block, and the 8×8 pixel macro block will be collectively referred to as “medium-size macro block”. The 8×4 pixel macro block, the 4×8 pixel macro block, and the 4×4 pixel macro block will be collectively referred to as “small-size macro block”. Table 10 shows a motion vector precision table which is selected for a large-size macro block. Table 11 shows a motion vector precision table which is selected for a medium-size macro block. Table 12 shows a motion vector precision table which is selected for a small-size macro block. Note that two, or four, or more motion vector precision tables may be defined based upon the size of the macro block.

TABLE 10

QUANTIZATION SCALE

| | SMALL | LARGE |
|---|---|---|
| MOTION VECTOR PRECISION | ¼ PIXELS | ¼ PIXELS |

TABLE 11

QUANTIZATION SCALE

| | SMALL | LARGE |
|---|---|---|
| MOTION VECTOR PRECISION | ¼ PIXELS | ½ PIXELS |

TABLE 12

QUANTIZATION SCALE

| | SMALL | LARGE |
|---|---|---|
| MOTION VECTOR PRECISION | ¼ PIXELS | 1 PIXEL |

The motion vector is acquired for each macro block. Accordingly, as the size of the macro block is smaller, the overall number of the motion vectors in the frame is greater. For example, in the coding of the frame with the 4×4 pixel macro blocks, 16 times more motion vectors are created than are created in the coding of the frame with the 16×16 pixel macro blocks. Accordingly, the coding of the frame with the 4×4 pixel macro blocks requires a greater amount of motion vector code. Accordingly, in a case of the coding of a frame using a large quantization scale with a reduced macro block size, the motion vector precision is reduced according to the reduction in the macro block size so as to reduce the coding amount of the motion vector code. With the above arrangement, in a case of the coding of a frame with a large-size macro block, the motion vector precision is set to a fixed high precision value (Table 10). On the other hand, in a case of the coding of the frame with a large quantization scale, and with a medium-size macro block, or a small-sized macro block, the motion vector precision is set to a medium precision value (Table 11) or a small precision value (Table 12).

With the present embodiment 2 described above, the motion vector precision is adjusted in units of macro blocks according to the quantization scale. This suppresses unnecessary high-precision acquisition of the motion vector code, thereby reducing the coding amount of the motion vector code. This reduces the overall coding amount while suppressing adverse effects on the image quality. Furthermore, with the present embodiment, the motion vector precision table is defined in the input stream. Such an arrangement provides adjustment options such as an adjustment option of whether or not the motion vector precision is adjusted, an adjustment option in which precision of the motion vector is selected, and so forth. Note that the adjustment option may be switched in finer units than those of the input-stream unit. This allows the degree to which the present embodiment applied to the coding of a moving image to be adjusted as appropriate according to the circumstances, thereby effectively providing the above-described advantages.

Description has been made regarding the embodiment 2 with reference to the examples. The above-described examples have been described for exemplary purposes only, and are by no means intended to be interpreted restrictively. Rather, it can be readily conceived by those skilled in this art that various modifications may be made by making various combinations of the aforementioned components or the like, which are also encompassed in the technical scope of the embodiment 2.

For example, in the aforementioned example, the motion vector search is performed for the next macro block with the motion vector precision corresponding to the quantization scale adjusted in the motion vector search for a given macro block. Also, an arrangement may be made in which the motion vector search is performed again for a given macro block with the motion vector precision corresponding to the quantization scale adjusted in the first-time motion vector search for this macro block. Such an arrangement provides higher-precision adjustment of the motion vector corresponding to the quantization scale.

On the other hand, let us consider a case in which the quantization scale is not adjusted according to the coding amount, but the quantization scale is determined for the input stream beforehand. In this case, an arrangement may be made in which the information with respect to the quantization scale is acquired from the input stream or other recording media, and the motion vector precision table is selected as a reference table based upon the size of the quantization scale in the same way as in the present embodiment 2. Such an arrangement provides the same advantages as those of the present embodiment 2.

### Embodiment 3

Background of this Embodiment

The rapid development of broadband networks has increased consumer expectations for services that provide high-quality moving images. On the other hand, large capacity storage media such as DVD and so forth are used for storing high-quality moving images. This increases the segment of users who enjoy high-quality images. A compression coding method is an indispensable technique for transmission of moving images via a communication line, and storing the moving images in a storage medium. Examples of international standards of moving image compression coding techniques include the MPEG-4 standard, and the H.264/AVC standard. Furthermore, the SVC (Scalable Video Coding) technique is known, which is a next-generation image compression technique that includes both high quality image streaming and low quality image streaming functions.

The H.264/AVC standard provides a function of adjusting the motion compensation block size, and a function of selecting the improved motion compensation pixel precision up to around ¼ pixel precision, thereby enabling finer prediction to be made for the motion compensation. Such a function requires an increased motion vector coding amount. On the other hand, in the development of SVC (Scalable Video Coding), which is a next-generation image compression technique, the MCTF (Motion Compensated Temporal Filtering) technique is being studied in order to improve temporal scalability. The MCTF technique is a technique that combines a time-base sub-band division technique and a motion compensation technique. With the MCTF technique, motion compensation is performed in a hierarchical manner, leading to significantly increased information with respect to the motion vectors. As described above, according to the recent trends, the latest moving image compression coding techniques require an increased overall amount of data for the moving image stream due to the increased amount of information with respect to the motion vectors. This leads to a strong demand for a technique of reducing the coding amount due to the motion vector information.

Japanese Patent Application Laid-open Publication No. 2004-48522 discloses a coding method having a function of switching the motion vector coding precision in units of blocks. This allows the coding amount of the motion vectors for low-rate coding.

Summary of this Embodiment

Let us consider a case of coding a frame which has a large high-frequency component, and which has a strong correlation with a reference frame. In this case, high-precision motion compensation with a high motion vector precision reduces the prediction error. On the other hand, let us consider a case of coding a frame having a small correlation with the reference frame due to an object in the frame moving at a high speed, or let us consider a case of coding a frame having a small high-frequency component. In such cases, high-precision motion compensation does not contribute to the reduction in the prediction error. That is to say, in such cases, high-precision information with respect to the motion vectors is unnecessary.

An embodiment 3 has been made in view of the aforementioned problems. Accordingly, it is an object thereof to provide a coding technique for moving images, which has a function of reducing the coding amount arising from the motion vector information.

In order to solve the aforementioned problems, an aspect of the embodiment 3 provides a coding technique for creating coded data having multiple layers (hierarchical classes) in a scalable manner from moving images, having a function of adjusting the precision of the motion vector, which is to be used for motion compensation prediction, for each layer.

According to such an aspect of the embodiment 3, a suitable motion vector precision is employed for each layer. This suppresses the unnecessary parts of the motion vector coding amount, which do not contribute to a reduction in prediction error, thereby improving the compression efficiency for the moving image. Examples of the scalability types which can be employed include the temporary scalability and the spatial scalability.

The multiple layers with different frame rates may be created by performing motion compensation temporal filtering for a moving image in a recursive manner. Also, the aforementioned method can be applied to a coding method for creating the multiple layers with different frame rates by performing motion compensation temporal filtering for a moving image according to the MCTF technique. Such an arrangement enables the coding amount of the motion vector information to be reduced in the MCTF processing in which the motion vector information is obtained for each layer, thereby improving the compression efficiency for the moving image.

An arrangement may be made in which correlation information that indicates the relation between the layer and the motion vector precision is established beforehand, and the correlation information thus established is included in the coded data of the moving image. This allows the motion vector precision, which is to be used for motion compensation prediction for each layer, to be determined for each coded data stream.

Also, an arrangement may be made in which correlation information that indicates the relation between the layer and the motion vector precision is established for each set of a predetermined number of pictures, and the correlation information thus established is included in coded data of the moving image. This allows the motion vector precision, which is to be used for motion compensation prediction for each layer, to be determined for each set of a predetermined number of pictures such as GOP.

Note that the term “picture” as used here represents a coding unit. Examples of the coding units include a frame, a field, a VOP (Video Object Plane), etc.

Also, an arrangement may be made in which the relation between the layer and the motion vector precision is established beforehand, and the motion vector precision is determined for each layer according to the relation thus established. With such an arrangement, the coded data does not need to include the correlation information that indicates the relation between the layer and the motion vector precision.

Also, the motion vector precision may be changed in a stepped manner according to the change in the layer. Also, the motion vector precision may be reduced according to the reduction in the frame rate of the layer. Let us consider a case in which the frame rate is reduced, and accordingly, the correspondence between adjacent frames is reduced. In general, reduction in the motion vector precision has little adverse effect on the prediction error. Accordingly, such an arrangement enables the coding amount of the motion vector information to be reduced, thereby improving the compression efficiency for the moving image.

Note that any combination of the aforementioned components or any manifestation of the embodiment 3 realized by modification of a method, device, system, computer program, and so forth, is effective as an embodiment of the embodiment 3.

Detailed Description of this Embodiment

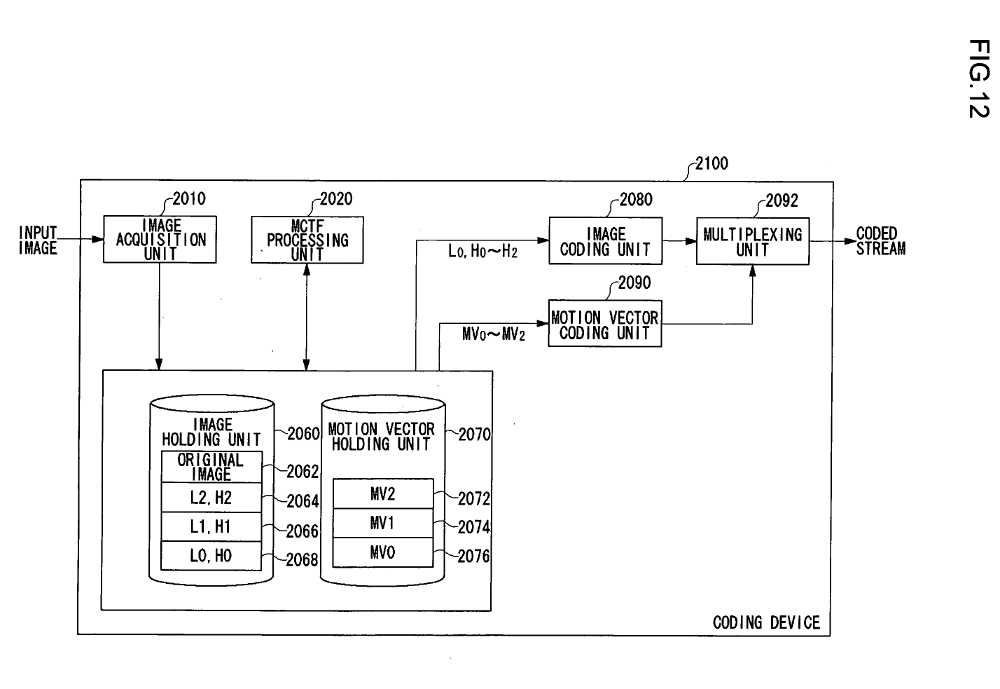

FIG. 12 is a configuration diagram which shows a coding device 2100 according to an embodiment 3. This configuration can be realized by hardware means, e.g., by actions of a CPU, memory, and other LSIs, of a computer, or by software means, e.g., by actions of a program having a function of image coding or the like, loaded into the memory. Here, the drawing shows a functional block configuration which is realized by cooperation between the hardware components and software components. It is needless to say that such a functional block configuration can be realized by hardware components alone, software components alone, or various combinations thereof, which can be readily conceived by those skilled in this art.

The coding device 2100 according to the present embodiment performs coding of moving images according to the H.264/AVC standard which is the newest moving image compression coding standard jointly standardized by the international standardization organization ISO (International Organization for Standardization)/IEC (International Electrotechnical Commission), and the international standardization organization with respect to electric communication ITU-T (International Telecommunication Union-Telecommunication Standardization Sector). Note that these organizations have advised that this H.264/AVC standard should be referred to as “MPEG-4 Part 10: Advanced Video Coding” and “H.264”, respectively.

An image acquisition unit 2010 of the coding device 2100 receives the GOP (Group of Pictures) of the input images, and stores each frame in a dedicated area in an image holding unit 2060. The image acquisition unit 2010 may divide each frame into macro blocks as necessary.

An MCTF processing unit 2020 performs motion compensated temporal filtering according to the MCTF technique. The MCTF processing unit 2020 obtains motion vectors based upon the frames stored in the image holding unit 2060, and performs temporal filtering using the motion vectors. The temporal filtering is performed using the Haar Wavelet transform. This decomposes the moving images into multiple layers which provide frame rates different from one another, and each of which has high-frequency frames and low-frequency frames. The high-frequency frames and the low-frequency frames thus decomposed are stored in a dedicated area of the image holding unit in a hierarchical manner. Also, the motion vectors are stored in a dedicated area of the motion vector holding unit 2070 in a hierarchical manner. Detailed description will be made later regarding the MCTF processing unit 2020.

Upon completion of the processing at the MCTF processing unit 2020, the high-frequency frames in all the layers and the low-frequency frames in the bottom layer, which are stored in the image holding unit 2060, are transmitted to an image coding unit 2080. The motion vectors in all the layers, which are stored in the motion vector holding unit 2070, are transmitted to a motion vector coding unit 2090.

The image coding unit 2080 performs spatial filtering for the frames, which have been supplied from the image holding unit 2060, using the Wavelet transform, and performs coding thereof. The coded frames are transmitted to a multiplexing unit 2092. The motion vector coding unit 2090 performs coding of the motion vectors supplied from the motion vector holding unit 2070, and supplies the coded motion vectors to the multiplexing unit 2092. The coding is performed using a known method, and accordingly, detailed description thereof will be omitted.

The multiplexing unit 2092 multiplexes the coded frame information received from the image coding unit 2080 and the coded motion vector information received from the motion vector coding unit 2090, thereby creating a coded stream.

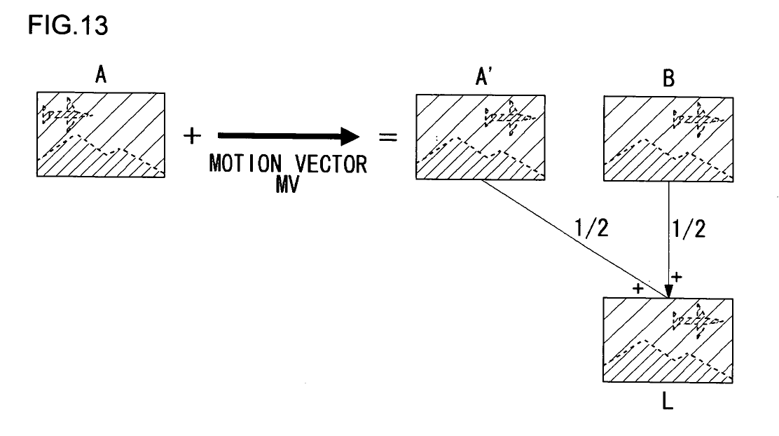

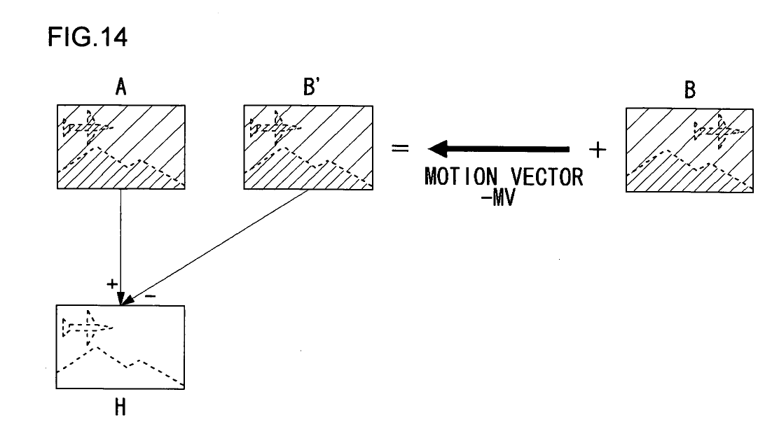

Next, description will be made regarding the temporal filtering processing according to the MCTF technique with reference to FIGS. 13 and 14.

The MCTF processing unit 2020 acquires two consecutive frames in a GOP, and creates a high-frequency frame and a low-frequency frame. Here, the aforementioned two consecutive frames will be referred to, in time order, as “frame A” and “frame B”.

The MCTF processing unit 2020 detects the motion vector MV based upon the frame A and frame B. For the purpose of simplification, FIGS. 13 and 14 show an example in which the motion vector is detected for each frame. Also, the motion vector may be detected for each macro block. Alternately, the motion vector may be detected for each block (e.g., 8×8 pixel block, 4×4 pixel block, etc.).

Next, motion compensation is performed for the frame A using the motion vector MV, thereby creating the motion-compensated frame A (which will be referred to as “frame A′” hereafter).

The low-frequency frame L is created by calculating the average of the frame A′ and the frame B as shown in FIG. 13.
L=½·(A′+B) (1)

Next, motion compensation is performed for the frame B using −MV, which is the inverted value of the motion vector MV, thereby creating the motion-compensated frame B (which will be referred to as “frame B′” hereafter).

The high-frequency frame H is defined as the subtraction image between the frame A and the frame B′ as shown in FIG. 14.
H=A−B′ (2)

Then, Expression (2) is transformed.
A=B′+H (3)

Then, motion compensation is performed for both sides of Expression (3) using the motion vector MV, thereby introducing the following Expression. Note that the frame “H′” represents an image obtained by performing motion compensation for the high-frequency frame H using the motion vector MV.
A′=B+H′ (4)

Then, Expression (4) is substituted into Expression (1), thereby introducing the following Expression.

$$\begin{matrix}L = 1 / 2 \cdot ( {A}^{′} + B ) \\ = 1 / 2 \cdot ( B + {H}^{′} + B ) \\ = B + 1 / 2 \cdot {H}^{′}\end{matrix} \qquad ( 5 )$$

That is to say, the low-frequency frame L can be created by calculating the sum of each pixel value of the frame B and half the pixel value of the corresponding pixel of the high-frequency frame H′.

Then, the low-frequency frames L thus created are employed as a new frame A/frame B set. The same operation as described above is repeatedly performed, thereby creating the high-frequency frame, the low-frequency frame, and the motion vector, in the next layer. This processing is repeated in a recursive manner until the newly-created layer includes only a single low-frequency frame. Accordingly, the number of the created layers is determined by the number of the frames included in the GOP. For example, let us consider a case in which the GOP includes eight frames. In this case, the first operation creates four high-frequency frames and four low frequency frames (layer 2). Then, the second operation creates two high-frequency frames and two low-frequency frames (layer 1). Then, the third operation creates a single high-frequency frame and a single low-frequency frame (layer 0).

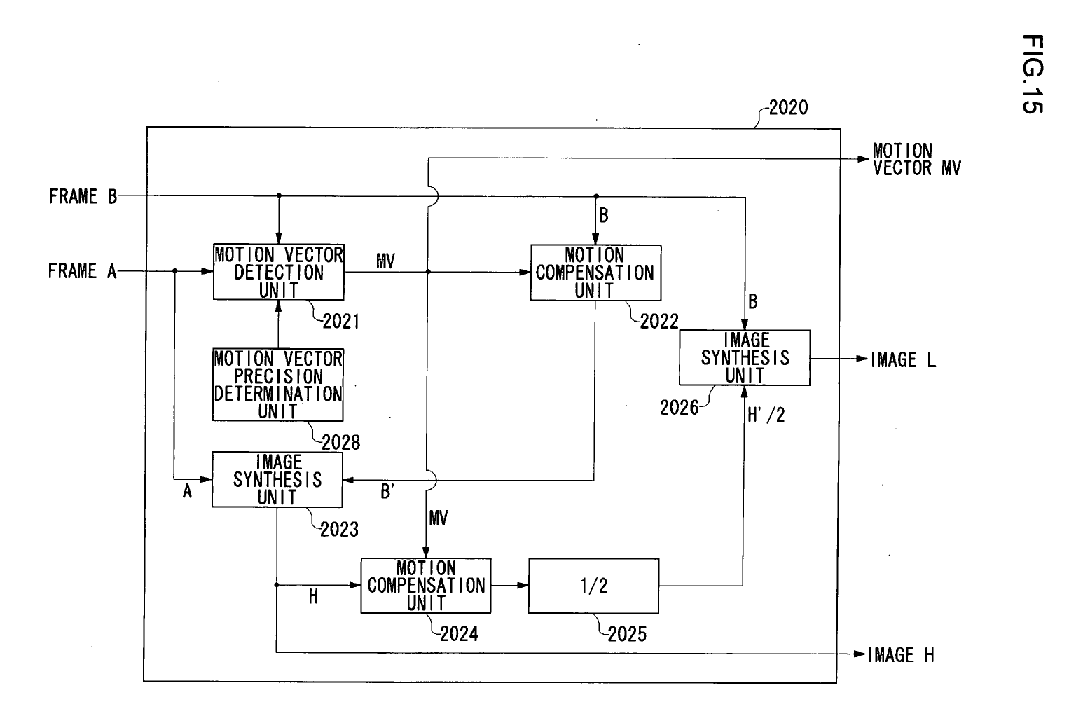

FIG. 15 shows a configuration of the MCTF processing unit 2020. A motion vector detection unit 2021 receives the frame A and the frame B stored in the image holding unit 2060. Note that the layer 2 includes the frames A and B which form the GOP. On the other hand, the layers lower than the layer 2 include the low-frequency frames L, which have been created based upon the frames in the immediately upper layer, in the form of the frames A and B, as described above.

A motion vector precision determination unit 2028 determines the motion vector precision, i.e., the pixel pitch at which motion vector detection is performed, which is used for motion compensation prediction, and transmits the motion vector precision to the motion vector detection unit 2021. As described above, with the present embodiment 3, the motion vector precision can be determined for each layer. Accordingly, the motion vector precision determination unit 2028 determines the layer of the motion compensation being performed for the frames in this step, and determines the motion vector precision corresponding to the layer in this step.

The motion vector detection unit 2021 searches the frame A for a predicted region that exhibits the smallest difference for each macro block in the frame B, thereby obtaining the motion vectors MV each of which represents the shift from the macro block to the predicted region. In this step, the motion vector detection unit 2021 obtains the motion vector MV with the precision received from the motion vector precision determination unit 2028. The motion vectors MV are stored in the motion vector holding unit 2070. At the same time, the motion vectors MV are supplied to motion compensation units 2022 and 2024.

The motion compensation unit 2022 performs motion compensation for the frame B using −MV, which is obtained by inverting the motion vector MV output from the motion vector detection unit 2021, in units of macro blocks, thereby creating the frame B′.

An image synthesizing unit 2023 calculates the sum of the frame A and the frame B′ output from the motion compensation unit 2022 in units of pixels, thereby creating a high-frequency frame H. The high-frequency frame H is stored in the image holding unit 2060, and is supplied to the motion compensation unit 2024. The motion compensation unit 2024 performs motion compensation of the high-frequency frame H using the motion vector MV in units of macro blocks, thereby obtaining the frame H′. The frame H′ thus obtained is multiplied by ½ at a processing block 2025, and the frame H′ thus multiplied by ½ is supplied to an image synthesizing unit 2026.

The image synthesizing unit 2026 makes the sum of the frame B and the frame H′ in units of pixels, thereby creating a low-frequency frame L. The low-frequency frame L thus created is stored in the image holding unit 2060.

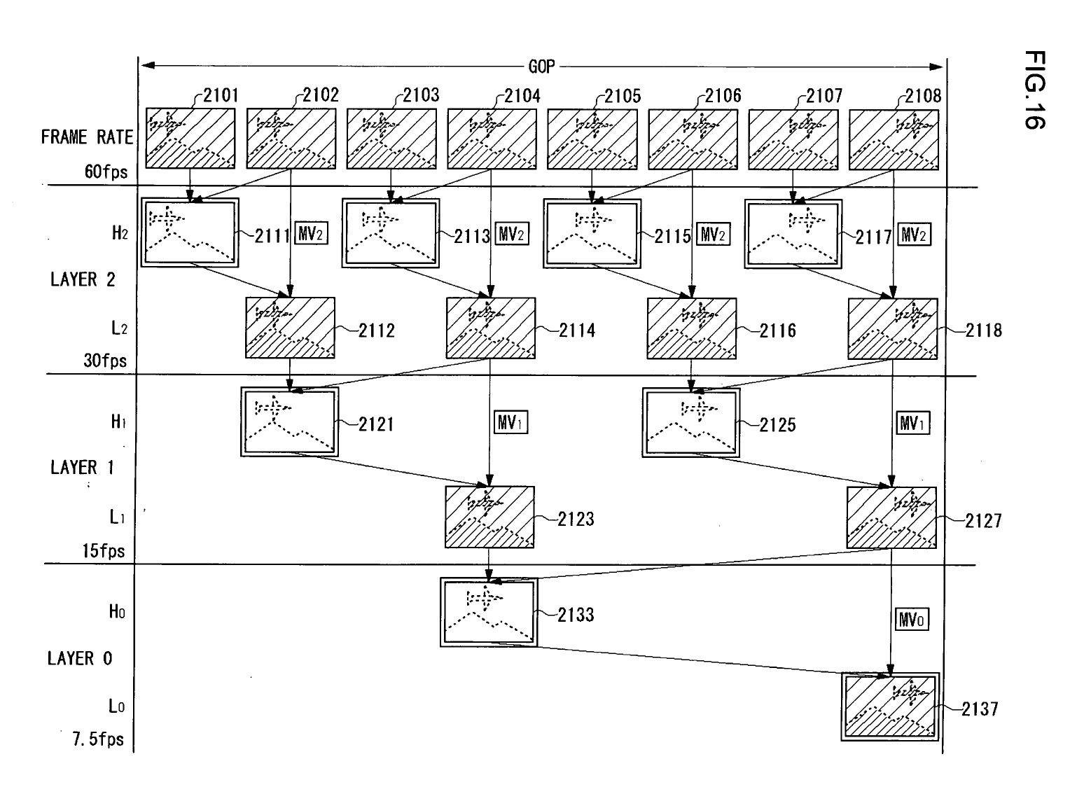

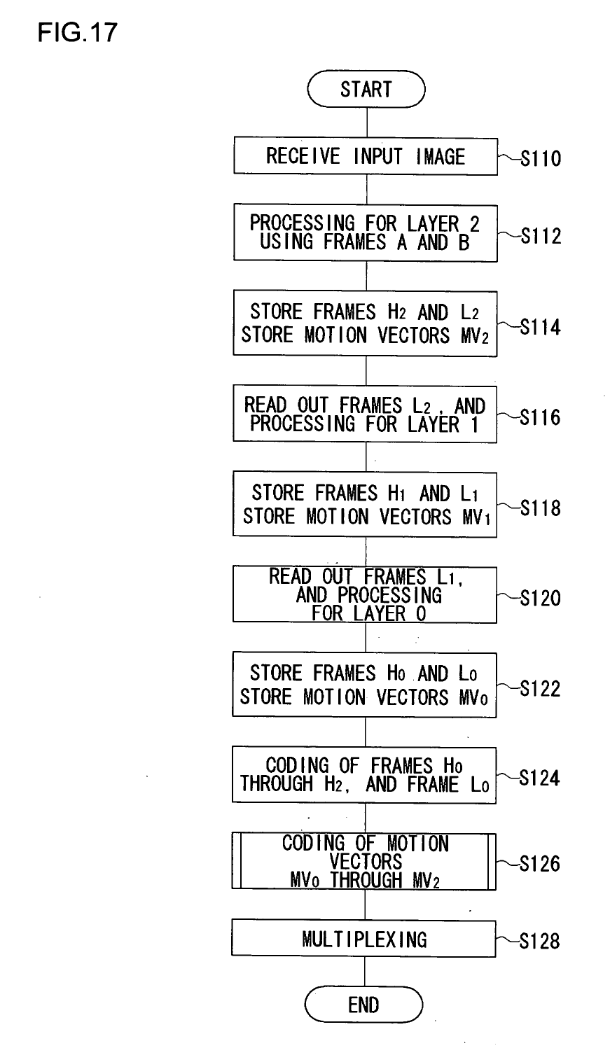

FIG. 16 is a diagram which shows the images and motion vectors output by the operation in each layer in a case of using the GOP which consists of eight frames. FIG. 17 is a flowchart which shows a coding method according to the MCTF technique. Specific examples will be described with reference to FIGS. 16 and 17.

Hereafter, the high-frequency frame, the low-frequency frame, and the motion vector in the layer n will be referred to as “Hn”, “Ln”, and “MVn”, respectively. In the example shown in FIG. 16, of the frames 2101 through 2108 in the GOP, the frames 2101, 2103, 2105, and 2107, are used as the frames A. On the other hand, the frames 2102, 2104, 2106, and 2108, are used as the frames B.

First, the image acquisition unit 2010 receives the frames A and B, and stores these frames in the image holding unit 2060 (S110). In this step, the image acquisition unit 2010 may divides each frame into macro blocks. Subsequently, the MCTF processing unit 2020 reads out the frames A and B from the image holding unit 2060, and executes the first temporal filtering processing (S112). The high-frequency frames H2 and the low-frequency frames L2 thus created are stored in the image holding unit 2060, and the motion vectors MV2 thus created are stored in the motion vector holding unit 2070 (S114). Upon completion of the processing for the frames 2101 through 2108, the MCTF processing unit 2020 reads out the low-frequency frames L2 from the image holding unit 2060, and executes the second temporal filtering processing (S116). The high-frequency frames H1 and the low frequency frames L1 thus created are stored in the image holding unit 2060, and the motion vectors MV1 thus created are stored in the motion vector holding unit 2070 (S118). Subsequently, the MCTF processing unit 2020 reads out the two low-frequency frames L1 from the image holding unit 2060, and executes the third temporal filtering processing (S120). The high-frequency frame H0 and the low-frequency frame L0 thus created are stored in the image holding unit 2060, and the motion vectors MV0 are stored in the motion vector holding unit 2070 (S122).

The high-frequency frames H0 through H2, and the low-frequency frame L0, are coded by the image coding unit 2080 (S124). On the other hand, the motion vectors MV0 through MV2 are coded by the motion vector coding unit 2090 (S126). The coded frames and the coded motion vectors are multiplexed by the multiplexing unit 2092, and are output in the form of a coded stream (S128).

The high-frequency frame H is a subtraction image made between frames, and accordingly, the coded high-frequency frame H has a reduced amount of data. On the other hand, each low-frequency frame L is the average of the frames in the upper layer. Accordingly, one instance of the temporal filtering processing reduces the number of the low-frequency frames by half while maintaining the image quality and the resolution of the frames at the same level, as can be understood with reference to FIG. 16. As a specific example, let us consider a case in which the original moving images are provided at 60 fps. In this case, as the layer is lower, so the frame rate is also lower. Specifically, the frame rate is 30 fps in the layer 2, 15 fps in the layer 1, and 7.5 fps in the layer 0. Thus, such an arrangement enables a moving image to be transmitted with multiple kinds of frame rates in the form of a single bit stream.

Upon receiving the coded stream, the decoding device executes decoding processing in order starting with the lowest layer. In a case of decoding only the frames in lower layers, the moving images at a low frame rate are obtained. As the layer in which the frames have been decoded is higher, so the frame rate of the moving image thus obtained is also higher. As described above, the temporal filtering according to the MCTF technique provides temporal scalability.

With the present embodiment 3, the motion vector precision determination unit 2028 has a function of adjusting the motion vector precision used for the motion compensation prediction for each layer. Here, the relation between each layer and the motion vector precision may be determined in the form of a coding standard, or may be determined as desired. For example, let us consider a case in which the motion vector precision is set for each layer. In this case, the motion vector precision data is stored in the header of each layer in the coded stream. On the other hand, in a case that the relation between each layer and the motion vector precision is determined according to a standard, there is no need to store the information with respect to such a relation in the coded stream.

Also, an arrangement may be made in which the relation between each layer and the motion vector precision is determined for each coded stream. With such an arrangement, the information with respect to such a relation is stored in the overall header of the coded stream. Also, an arrangement may be made in which the relation between each layer and the motion vector precision is determined for each group formed of a predetermined number of pictures, such as a GOP or the like. With such an arrangement, the information with respect to such a relation is stored in the header of the GOP or the like.

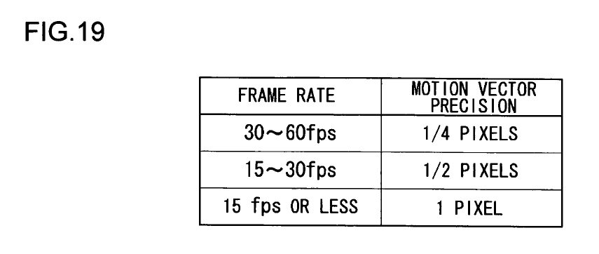

FIG. 19 shows an example of the relation between the frame rate of each layer and the motion vector precision. In this example, in a case of a layer frame rate of 30 through 60 fps, the motion vector precision is set to around ¼ pixels. In a case of a layer frame rate of 15 through 30 fps, the motion vector precision is set to around ½ pixels. In a case of a layer frame rate of 15 fps or less, the motion vector precision is set to around 1 pixel. The aforementioned motion vector precision determination unit 2028 provides the motion vector precision, which corresponds to the frame rate of the layer for which the motion compensation is to be performed, to the motion vector detection unit 2021 with reference to the table shown in FIG. 19. The motion vector precision determination unit 2028 may determine the motion vector precision for each layer such that the subtraction image exhibits the smallest coding amount, instead of the aforementioned arrangement in which the motion vector precision is determined for each layer according to a predetermined table as shown in FIG. 19. Also, the motion vector precision determination unit 28 may receive the information with respect to the motion vector precision for each layer from external circuits before coding.

As shown in FIG. 19, the motion vector precision is preferably reduced according to the reduction in the frame rate of the layer. The reason is as follows. That is to say, in general, in a case of reducing the frame rate, i.e., in a case of increasing the temporal interval between adjacent frames, the correlation between the adjacent frames is reduced. Accordingly, in this case, searching with an increased motion vector precision does not ensure that the subtraction values of the subtraction image are reduced. In other words, let us consider a case in which searching with an increased precision of the motion vector provides a subtraction image with reduced subtraction values. In this case, the increased number of bits necessary for the coding of the motion vector is taken up by the reduced subtraction values of the subtraction image described above, thereby reducing the overall coding amount. Accordingly, with the present embodiment, the motion vector precision is reduced (i.e., the coding amount of the motion vector is reduced) according to the reduction in the frame rate of the layer, thereby improving the coding efficiency for the moving images. Note that, in some cases, searching with a reduced motion vector precision according to the increase of the frame rate of the layer leads to a reduction in the coding amount of moving images. In this case, an arrangement may be made in which the motion vector precision is reduced according to the increase of the frame rate of the layer.

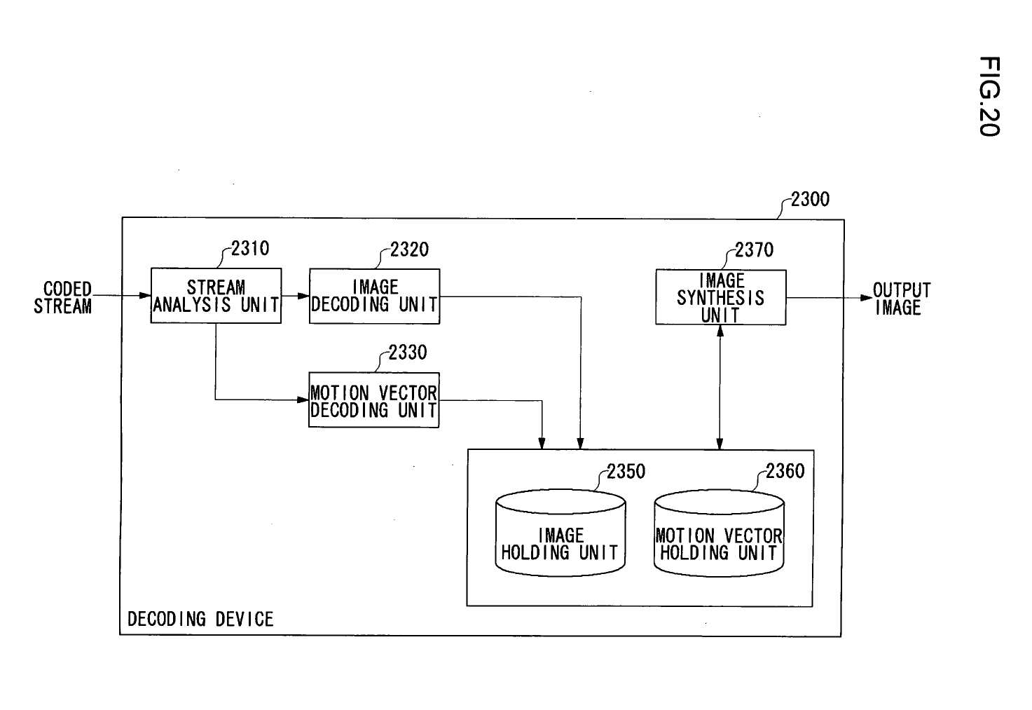

FIG. 20 is a configuration diagram which shows a decoding device 2300 according to the embodiment 3. A stream analysis unit 2310 of the decoding device 2300 receives the coded stream as input data. The stream analysis unit 2310 extracts the necessary data segment corresponding to the layer, and separates the data segment into the coded data of the frames and the coded data of the motion vectors. The frame data is supplied to an image decoding unit 2320. On the other hand, the motion vector data is supplied to a motion vector decoding unit 2330. In a case that the coded stream includes the motion vector precision data, the precision data is also separated out, and the precision data thus separated out is supplied to the motion vector decoding unit 2330.

The image decoding unit 2320 performs entropy decoding and inverse wavelet transform for the frame data, thereby creating the low-frequency frame L0 in the bottom layer, and the high-frequency frames H0 through H2 in all the layers. The frames thus decoded by the image decoding unit 2320 are stored in a dedicated area of the image holding unit 2350.

The motion vector decoding unit 2330 decodes the motion vector information using the motion vector precision data. Then, the motion vector decoding unit 2330 calculates the motion vectors MV0 in the bottom layer, and the motion vectors MV1 and MV2 in higher layers. The motion vectors thus decoded by the motion vector decoding unit 2330 are stored in a dedicated area of the motion vector holding unit 2360.

An image synthesis unit 2370 creates frames in an inverse manner to that of the aforementioned MCTF processing. The frames thus synthesized are output to external circuits. Also, in a case of requesting the frames in a higher layer, the frames thus synthesized are stored in the image holding unit 2350 for the subsequent processing.

With the present embodiment, one instance of the synthesis processing performed by the image synthesis unit 2370 increases the frame rate, at which the moving images are reproduced, by an amount corresponding to the raised layer. Repeated instances of the synthesis processing can increase the frame rate up to that at which the input images had been provided, which is the highest frame rate obtained by the image decoding unit 2320.

As described above, with the coding device 2100 according to the present embodiment 3, the motion vectors are coded with a suitable motion vector precision for each temporal scalability layer, thereby reducing the coding amount of the motion vector information. In general, coding of a moving image in a hierarchical manner requires a markedly increased motion vector coding amount. Accordingly, there is a demand for an efficient coding method for coding the motion vectors. With the present embodiment 3, the compression efficiency is improved while reducing the overall coding amount of the moving image stream.

The present embodiment 3 provides a coding device giving consideration to the correlation between the layers and the motion vector precision. Let us consider a case in which the frame includes a large high-frequency component, and has a strong correlation with the reference frame. In this case, prediction error can be reduced by executing high-precision motion compensation with increased motion vector precision. On the other hand, let us consider a case in which there is a small correlation between the frame and the reference frame due to an object in the frame moving at a high speed, or a case in which the frame has a small high-frequency component. In this case, motion compensation with increased precision does not contribute the reduction in the prediction error. That is to say, in this case, the high-precision information with respect to the motion vectors is unnecessary. With the present embodiment 3, a moving image is coded using a suitable motion vector precision for each layer. This suppresses excessive motion vector coding amount that does not contribute to a reduction in the prediction error, thereby improving the compression efficiency of the moving image.

Let us consider an arrangement in which coding is performed with a motion vector precision adjusted for each macro block, instead of an arrangement according to the present embodiment in which the same precision of the motion vector is set for each layer. With such an arrangement, while the coding amount of the motion vectors is reduced, the computation amount required for coding is increased. On the other hand, with the present embodiment 3, the coding amount of the motion vectors is reduced without increasing the computation amount.

In particular, with regard to the coding of a moving image using temporal filtering according to the MCTF technique, there is a need to perform coding of motion vectors for each layer, and accordingly, such coding requires a markedly increased coding amount of the motion vector information. Accordingly, the present embodiment can be effectively applied to such coding.

Description has been made regarding the embodiment 3 with reference to the examples. The above-described examples have been described for exemplary purposes only, and are by no means intended to be interpreted restrictively. Rather, it can be readily conceived by those skilled in this art that various modifications may be made by making various combinations of the aforementioned components or the aforementioned processing, which are also encompassed in the technical scope of the embodiment 3.

Description has been made above regarding an arrangement in which the motion vector precision is adjusted in the MCTF processing using the Haar-Wavelet transform for creating a single low frequency frame based upon two consecutive frames. Also, the embodiment 3 can be applied to an arrangement in which the motion vector precision is adjusted in the MCTF processing using 5/3 Haar-Wavelet transform for creating a single high-frequency frame based upon three consecutive frames.

Description has been made above regarding an arrangement in which the coding device 2100 and the decoding device 2300 perform coding and decoding of moving images according to the H.264/AVC standard. Also, the embodiment 3 can be applied to other methods for performing coding and decoding of moving images in a hierarchical manner with temporal scalability.

Description has been made above regarding an arrangement in which coding is performed for moving images with temporal scalability. Also, the coding of motion vectors according to the embodiment 3 can be applied to an arrangement in which coding is performed for moving images with spatial scalability.

What is claimed is:

1. A coding method wherein a plurality of regions are defined in pictures which are components of a moving image, and which are to be subjected to inter-picture prediction coding,
and wherein conditions for motion vector coding are set for each region.

2. A coding method according to claim 1, wherein said conditions for motion vector coding are conditions with respect to the pixel precision for motion compensation.

3. A coding method according to claim 1, wherein said conditions for motion vector coding are conditions with respect to the maximum value possible for the motion vector.

4. A coding method according to claim 1, wherein said conditions for motion vector coding are included in coded data of said moving images in a form in which a set of corresponding conditions is correlated with each region where said conditions are to be applied.

5. A coding method according to claim 1, wherein a region occupied by an object extracted from said moving images is set as one of said plurality of regions.

6. A coding method according to claim 1, wherein a background region in said moving images is set as one of said plurality of regions.

7. A coding method for inter-picture prediction coding of moving images comprising:
a step for performing motion vector search based upon a coding target picture and a reference picture, and creating a motion vector for the coding target picture and a predicted image; and
a step for quantizing the values that correspond to the subtraction image between the coding target picture and the predicted image,
wherein, in the step for creating the motion vector and the predicted image, the motion vector searching is performed with the precision corresponding to the quantization scale used in the step for the quantization.

8. A coding method according to claim 7, wherein, in the step for creating the motion vector and the predicted image, the motion vector searching is performed with the precision obtained based upon the quantization scale with reference to a motion vector precision table which indicates a predetermined relation between the quantization scale and the precision.

9. A coding method according to claim 7, further comprising a step for selecting one motion vector precision table from among multiple motion vector precision tables, which indicate different predetermined relations between the quantization scale and the motion vector precision, based upon at least one of a set of predetermined properties of the moving image and the kind of the coding method,
wherein, in the step for creating the motion vector and the predicted image, the motion vector searching is performed with the precision obtained with reference to a motion vector precision table selected based upon the quantization scale.

10. A coding method according to claim 7, wherein a stream formed of the moving image includes identification information which allows a particular motion vector precision table to be specified from among multiple motion vector precision tables which indicate different predetermined relations between the quantization scale and the motion vector precision,
and wherein, in the step for creating the motion vector and the predicted image, the motion vector searching is performed with the precision obtained with reference to the motion vector precision table specified by the quantization scale.

11. A coding method according to claim 8, wherein a stream formed of the moving image includes the motion vector precision table.

12. A coding method according to claim 8, wherein a stream formed of the moving image includes a plurality of the motion vector precision tables in the predetermined units that form the moving image.

13. A coding method according to claim 8, wherein the motion vector precision table includes a relation indicating that the motion vector precision is reduced according to the increase in the quantization scale.

14. A coding method for creating coded data having multiple layers with scalability based upon moving images,
wherein the motion vector precision used for motion compensation prediction can be adjusted for each layer.

15. A coding method according to claim 14, wherein a correlation is determined beforehand between the layers and the motion vector precision,
and wherein the coded data of the moving images includes the correlation information.

16. A coding method according to claim 14, wherein a correlation between the layers and the motion vector precision is determined for each set of a predetermined number of pictures,
and wherein the coded data of the moving images includes the correlation information.

17. A coding method according to claim 14, wherein a correlation is determined beforehand between the layers and the motion vector precision,
and wherein the motion vector precision is determined for each layer according to the correlation information.

18. A coding method according to claim 14, wherein the motion vector precision is determined for each layer such that it is changed in a stepped manner according to the change in the layer.
